(19) United States
(12) Patent Application Publication
(10) Pub. No.: US 2024/0357521 A1
(43) Pub. Date: Oct. 24, 2024

(54) ELECTRONIC DEVICE, COMMUNICATION METHOD AND COMPUTER PROGRAM PRODUCT

(71) Applicant: Sony Group Corporation, Tokyo (JP)

(72) Inventors: Zhengyi ZHOU, Beijing (CN); Fan ZHANG, Beijing (CN); Zhaocheng WANG, Beijing (CN); Jianfei CAO, Beijing (CN)

(73) Assignee: Sony Group Corporation, Tokyo (JP)

(21) Appl. No.: 18/685,239

(22) PCT Filed: Aug. 29, 2022
(86) PCT No.: PCT/CN2022/115470

§ 371 Date: Feb. 21, 2024

(30) Foreign Application Priority Data
Sep. 3, 2021 (CN) 202111029861.9

(51) Int. Cl. H04W 56/00; H04L 5/00

(52) U.S. Cl. CPC H04W 56/0005; H04L 5/0035; H04W 56/0045

(57) ABSTRACT

The present disclosure relates to electronic device, communication method and computer program product in a wireless communication system. An electronic device on user side is provided, comprising a processing circuitry configured to receive a configuration on a plurality of timing advances (TAs) associated with a plurality of transmit and receive points (TRPs), wherein the plurality of TAs have different values; and transmit uplink transmission frames to the plurality of TRPs simultaneously, wherein the uplink transmission frame transmitted to each of the TRPs is applied with a TA associated with the TRP.

### FIELD OF THE INVENTION

The present disclosure relates generally to the field of wireless communication, and more particularly, to enhancements on uplink communication based on multipoint transmission.

### BACKGROUND

With continuous developments of mobile internet services, various applications such as video call, outdoor live, mini video uploading, surveillance video backhaul or the like have increasing demands on uplink transmission, and a lot of attention has been paid to how to effectively improve reliability and effectiveness of the uplink transmission of a wireless communication system. Uplink communication based on multipoint transmission allows a user to perform signal transmissions to multiple transmit and receive points (TRPs), and is an important means for effectively improving the reliability and effectiveness of an uplink.

At present, all multipoint transmission methods are based on time division, that is, although a user maintains connections with multiple TRPs simulateously, the user communicates with only one TRP on the same moment, and the multipoint transmission is reflected in only allowing the user to switch a communication target among the multiple connected TRPs, but not to really perform signal transmissions with the multiple TRPs at the same time, which is not beneficial to improve the uplink transmission rate and link efficiency.

To further improve the communication performance, an idea is to allow the user to perform signal transmissions with multiple TRPs at the same time, which, however, may be constrained by existing standards. For example, it is difficult to directly follow existing uplink Timing Advance (TA) configuration methods and uplink precoding methods.

Therefore, there is a need to improve the existing uplink communication mechanism to support a user to communicate with multiple TRPs simultaneously.

### SUMMARY OF THE INVENTION

Aspects are provided by the present disclosure to satisfy the above-mentioned need. The present disclosure provides a timing advance configuration method and an uplink precoding method suitable for the multi-TRP transmission, so as to enable a user to communicate with multiple TRPs simultaneously, which is helpful to improve the reliability and effectiveness of the uplink transmission.

A brief summary regarding the present disclosure is given here to provide a basic understanding on some aspects of the present disclosure. However, it will be appreciated that the summary is not an exhaustive description of the present disclosure. It is not intended to identify key portions or important portions of the present disclosure, nor to limit the scope of the present disclosure. It aims at merely describing some concepts about the present disclosure in a simplified form and serves as a preorder of a more detailed description to be given later.

According to one aspect of the present disclosure, there is provided an electronic device on user side, comprising a processing circuitry configured to receive a configuration on a plurality of timing advances (TAs) associated with a plurality of transmit and receive points (TRPs), wherein the plurality of TAs have different values; and transmit uplink transmission frames to the plurality of TRPs simultaneously, wherein the uplink transmission frame transmitted to each of the TRPs is applied with a TA associated with the TRP.

According to one aspect of the present disclosure, there is provided an electronic device for a transmit and receive point (TRP), comprising a processing circuitry configured to send a configuration on a timing advance (TA) associated with the TRP to a user equipment (UE); and receive an uplink transmission frame corresponding to the TRP among uplink transmission frames transmitted by the UE simultaneously to a plurality of TRPs including the TRP, wherein the uplink transmission frames transmitted to the plurality of TRPs are applied with different TAs associated with respective TRPs.

According to one aspect of the present disclosure, there is provided an electronic device for a user equipment (UE), comprising a processing circuitry configured to receive, from a plurality of TRPs, a plurality of uplink precoding matrix indications and information on channel conditions between the UE and each of the TRPs; and based on the plurality of uplink precoding matrix indications and the information on the channel conditions, determine an uplink precoder for precoding uplink transmissions to the plurality of TRPs.

According to one aspect of the present disclosure, there is provided an electronic device for a transmit and receive point (TRP), comprising a processing circuitry configured to send, to a User Equipment (UE), an uplink precoding matrix indication and information on a channel condition between the UE and the TRP; and receive, from the UE, an uplink transmission subjected to uplink precoding, wherein the uplink precoding utilizes an uplink precoder determined by the UE based on uplink precoding matrix indications transmitted by a plurality of TRPs including the TRP and information on channel conditions between the UE and each of the TRPs.

According to one aspect of the present disclosure, there is provided a communication method comprising steps performed by each of the processing circuitry as described above.

According to one aspect of the present disclosure, there is provided a computer program product containing executable instructions which, when executed, perform the communication method as described above.

### BRIEF DESCRIPTION OF THE DRAWINGS

A better understanding of the present disclosure may be achieved by referring to a detailed description given hereinafter in connection with accompanying figures, where the same or similar reference signs are used to indicate the same or similar components throughout the figures. All drawings are included in the specification along with the following detailed descriptions and form a part of the specification, for further illustrating embodiments of the present disclosure and for explaining the theory and advantages of the present disclosure. Wherein,

FIG. 1 is a simplified diagram illustrating architecture of a NR communication system;

FIGS. 2A and 2B are NR radio protocol architectures for a user plane and a control plane, respectively;

FIG. 3 illustrates a typical uplink multipoint transmission scenario;

FIGS. 4A and 4B illustrate two operation modes of the multi-TRP uplink transmission, respectively;

FIG. 5 illustrates a frame structure of the NR communication system;

FIG. 6 illustrates uplink synchronization in the multipoint transmission scenario;

FIG. 7 illustrates an uplink synchronization procedure according to a first embodiment of the present disclosure;

FIGS. 8A and 8B illustrate signaling for configuring timing advance commands;

FIG. 9 illustrates a schematic diagram of a UE applying TA s on antenna ports;

FIG. 10 illustrates a comparison between conventional TA configuration and the TA configuration according to the first embodiment of the present disclosure;

FIG. 11 illustrates conventional layer mapping and the layer mapping according to the first embodiment;

FIG. 12 illustrates a comparison between conventional TA configuration and the TA configuration according to the first embodiment of the present disclosure;

FIGS. 13A and 13B are diagrams illustrating an electronic device on the UE side and a communication method thereof according to the first embodiment;

FIGS. 14A and 14B are diagrams illustrating an electronic device on the network control side and a communication method thereof according to the first embodiment;

FIG. 15 illustrates a schematic diagram for decision of a codebook-based uplink precoder;

FIG. 16 illustrates a schematic diagram for decision of an uplink precoder in the multi-point transmission scenario;

FIG. 17 illustrates a schematic diagram for decision of a non-codebook based uplink precoder;

FIG. 18 illustrates an example of the uplink precoding according to a second embodiment;

FIG. 19 illustrates a diagram of a TRP issuing channel condition information according to the second embodiment;

FIG. 20 illustrates another example of the uplink precoding according to the second embodiment;

FIG. 21 illustrates a schematic diagram of a TRP issuing an E-TPMI according to the second embodiment;

FIG. 22 illustrates a simulation graph of performances using a conventional TPMI and the E-TPMI according to the second embodiment;

FIGS. 23A and 23B are diagrams illustrating an electronic device on the UE side and a communication method thereof according to the second embodiment;

FIGS. 24A and 24B are diagrams illustrating an electronic device on the network control side and a communication method thereof according to the second embodiment;

FIG. 25 illustrates a first example of exemplary configuration of a base station according to the present disclosure;

FIG. 26 illustrates a second example of exemplary configuration of a base station according to the present disclosure;

FIG. 27 illustrates an exemplary configuration of a smart phone according to the present disclosure; and

FIG. 28 illustrates an exemplary configuration of a vehicle navigation device according to the present disclosure.

Features and aspects of the present disclosure will become apparent from the following description of exemplary embodiments with reference to the attached drawings.

### DESCRIPTION OF EMBODIMENTS

Various exemplary embodiments of the present disclosure will be described hereinafter with reference to the drawings. For purpose of clarity and simplicity, not all features of the embodiments are described in the specification. It should be noted that, however, many implementation-specific settings may be made in practicing the embodiments of the present disclosure according to specific requirements, so as to achieve specific goals of the developers, such as to comply with constraints related to devices and services, and these constraints may vary from one implementation to another. In addition, it should be noted that although the development work may be complex and laborious, such development work is only a routine task for those skilled in the art who benefit from the present disclosure.

In addition, it should be noted that to protect the present disclosure from being obscured by unnecessary details, the figures illustrate only steps of a process and/or components of a device that are closely related to at least technical solutions of the present disclosure, while other details that have little relation to the present disclosure are omitted. The following description of exemplary embodiments is merely illustrative, and is not intended to be any limitation on the present disclosure and application thereof.

For convenient explanation of the technical solutions of the present disclosure, various aspects of the present disclosure will be described below in context of the 5G NR. However, it should be noted that this is not a limitation on the scope of application of the present disclosure. One or more aspects of the present disclosure can also be applied to various existing wireless communication systems, such as the 4G LTE/LTE-A, or various wireless communication systems to be developed in future. The architecture, entities, functions, processes and the like as described in the following description are not limited to those in the NR communication system, but may find equivalents in other communication standards.

### System Overview

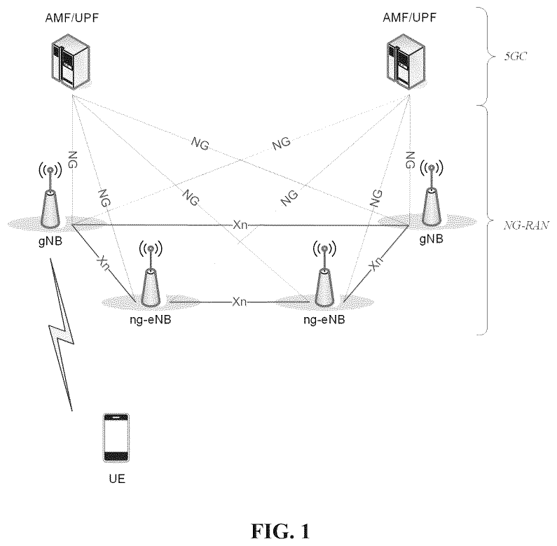

FIG. 1 is a simplified diagram illustrating an architecture of the NR communication system. As shown in FIG. 1, on the network side, radio access network (NG-RAN) nodes of the NR communication system include gNBs and ng-eNBs, wherein the gNB is a newly defined node in the 5G NR communication standard, is connected to a 5G core network (5GC) via a NG interface and provides NR user plane and control plane protocols terminating with a terminal equipment (also referred to as “user equipment”, simply referred to as “UE” hereinafter); the ng-eNB is a node defined to be compatible with the 4G LTE communication system, can be upgradation of an evolved Node B (eNB) of the LTE radio access network, is connected to the 5G core network via the NG interface, and provides user plane and control plane protocols for evolved universal terrestrial radio access (E-UTRA) terminating with the UE. Hereinafter. The gNB and ng-eNB are collectively referred to as a “base station”.

In the multipoint transmission, the base station may operate as a transmit and receive point (TRP). It should be noted that the term “base station” used in the present disclosure is not limited to the above two kinds of nodes, but is taken as an example of a control device on the network side and has a full breadth of its general meaning. For example, in addition to the gNB and ng-eNB specified in the 5G communication standard, the “base station” may also be, for example, an eNB in the LTE communication system, a remote radio head, a wireless access point, a control node in an automated plant, or a communication device that performs similar functions. Application examples of the base station will be described detailedly in the following chapter.

In addition, the term “UE” in the present disclosure has a full breadth of its general meaning, including various terminal devices or vehicle-mounted devices that communicate with a base station. For example, the UE may be a terminal device such as a mobile phone, a laptop computer, a tablet computer, a vehicle-mounted communication device, sensors and effectors in an automated plant or the like, or elements thereof. Application examples of the UE will be described detailedly in the following chapter.

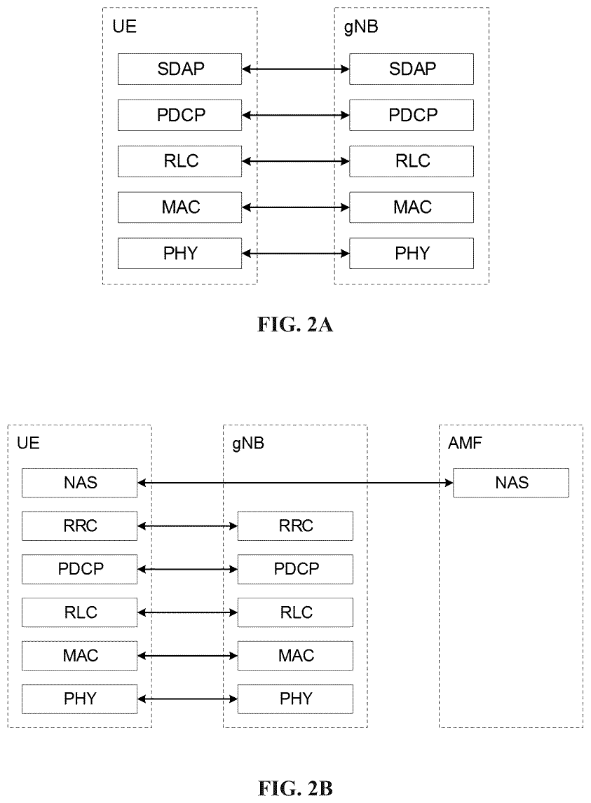

Next, a NR radio protocol architecture for the base station and the UE in FIG. 1 is explained with reference to FIGS. 2A and 2B. FIG. 2A illustrates a radio protocol stack in the user plane for the UE and the gNB, and FIG. 2B illustrates a radio protocol stack in the control plane for the UE and the gNB. The radio protocol stacks are shown to have three layers: Layer 1, Layer 2 and Layer 3.

Layer 1 (L1) as the lowest layer is also called a physical layer, and implements various physical-layer signal processing to provide transparent transmission for signals. L1 provides physical transport channels for upper layers.

Layer 2 (L2) is above the physical layer and is responsible for managing links between the UE and the base station above the physical layer. In the user plane and the control plane, L2 includes a medium access control (MAC) sublayer, a radio link control (RLC) sublayer, and a packet data convergence protocol (PDCP) sublayer, which terminate at the base station (ng-eNB, gNB) on the network side, and at the UE on the user side. In the user plane, a service data adaptation protocol (SDAP) sublayer is also included at the UE and the base station. In Layer 2, only the MAC sublayer is related to the mobility management, and thus Layer 2 mentioned in the present disclosure mainly refers to the MAC sublayer. In particular, the MAC sublayer is -s- responsible for allocating various radio resources (for example, resource blocks) in a cellular cell among the UEs.

In the control plane, Layer 3 (L3), namely, Radio Resource Control (RRC) layer, is also included at the UE and the base station. The RRC layer is responsible for obtaining radio resources (i.e., radio bearers) and for configuring lower layers using RRC signaling between the base station and the UE. In addition, the UE performs functions such as authentication, mobility management, security control and the like with a non-access stratum (NAS) control protocol in a core network (AMF).

New cellular communication technologies are continuously developed to increase coverage, ensure communication quality, better meet various requirements and use cases, and so on. The 5G NR pursues and develops the concept of multipoint transmission proposed in the 4G LTE, that is, a UE can maintain connections with multiple base stations (referred to as TRPs in the present disclosure) so that all of the multiple TRPs can serve this UE.

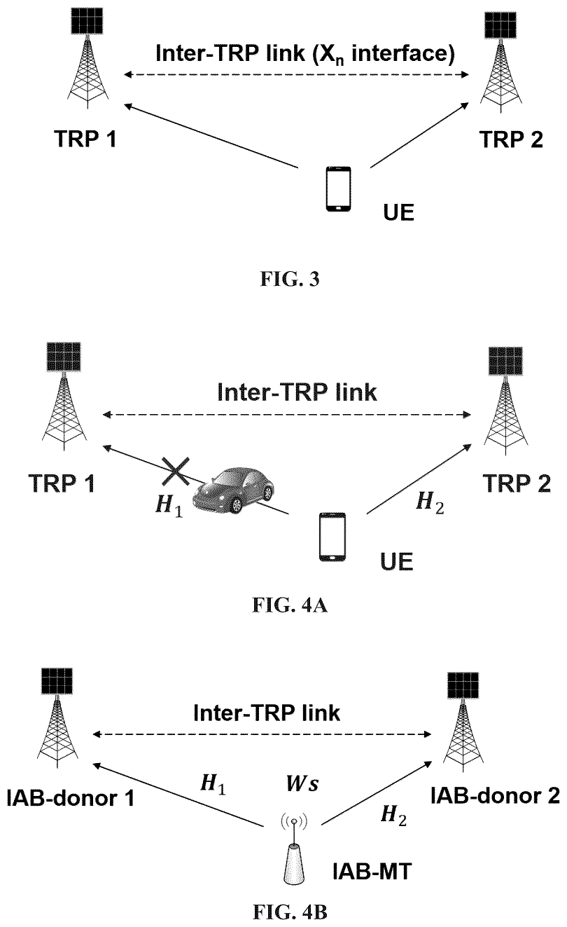

A typical uplink communication scenario based on the multipoint transmission is shown in FIG. 3. Taking two TRPs as example, the UE maintains RRC connections with TRP 1 and TRP 2 simultaneously, and transmits uplink signals to the two TRPs simultaneously. The two TRPs are geographically separated and may communicate with each other via an inter-TRP link (e.g., an Xn interface) to communicate scheduling information and transmission data regarding the UE. By using the multipoint transmission technology, performance of the uplink communication of the UE can be effectively enhanced.

FIGS. 4A and 4B show two operation modes of the multi-TRP uplink transmission, respectively. As shown in FIG. 4A, the UE may transmit the same data to two TRPs to obtain a diversity gain. Therefore, even if one TRP (such as TRP 1) cannot normally receive signals due to shielding or the like, the UE can maintain communication with the other TRP (such as TRP 2), so that the transmission quality is guaranteed, and the uplink reliability is improved. Mathematically, let channels from the UE to the TRP 1 and to the TRP 2 be H₁ and H₂, respectively, and received noise power at the two TRPs be σ², and in addition, assuming that a link failure threshold value is γ, then the link failure between the UE and the TRP 1 can be expressed as

$$\frac{{‖ {H}_{1} ‖}_{F}^{2}}{{σ}^{2}} < γ ,$$

which is denoted as Event [symbol] ₁, that is,

$${𝒜}_{1} = \{ \frac{{‖ {H}_{1} ‖}_{F}^{2}}{{σ}^{2}} < γ \} .$$

Similarly, the link failure between the UE and the TRP 2 is denoted as Event

$${𝒜}_{2} = \{ \frac{{‖ {H}_{2} ‖}_{F}^{2}}{{σ}^{2}} < γ \} ,$$

and the link failure of the UE in the multipoint transmission mode is Event

$${𝒜}_{3} = {𝒜}_{1} ⋂ {𝒜}_{2} = \{ \frac{{‖ {H}_{1} ‖}_{F}^{2}}{{σ}^{2}} < γ , \frac{{‖ {H}_{2} ‖}_{F}^{2}}{{σ}^{2}} < γ \} .$$

It can be seen that, since Event [symbol] ₃ is an intersection of [symbol] ₁ and [symbol] ₂ (only if two links fail at the same time, the link failure occurs in the multipoint transmission mode), a probability of occurrence of Event [symbol] ₃ is smaller than the possibility of isolated occurrence of [symbol] ₁ or [symbol] ₂. This means that in this mode of multipoint transmission, the reliability of the uplink of the UE is improved, and the diversity gain is obtained.

In addition, as shown in FIG. 4B, a UE may transmit different data to two TRPs to increase an uplink data rate and improve an effectiveness of the communication. A typical scenario is Integrated Access and Backhaul (IAB), where IAB-MT (IAB Mobile Termination) can simultaneously transmit data to multiple IAB Donors. Let channels from the IAB-MT to the two IAB Donors be H₁ and H₂, respectively, and in the multipoint transmission mode, an equivalent channel matrix is H=[H₁^{T} H₂^{T}]^{T}. According to MIMO theory, the number of spatial data streams transmitted in parallel does not exceed a rank of the channel matrix and rank ([H₁^{T} H₂^{T}]^{T})≥max{rank(H₁), rank(H₂)}, which means that in this multipoint transmission mode, the number of spatial data streams of the uplink transmission can be increased, so that the uplink rate and the link effectiveness are improved, and a multiplexing gain is obtained.

The multipoint transmission can improve the reliability and effectiveness of the uplink communication, but also has problems and challenges. On the one hand, in order to achieve uplink synchronization, different TRPs may configure different Timing Advances (TAs) for the UE, however, the existing standard supports the UE to use only one TA at the same time, and it is difficult to meet the requirement of uplink synchronization of transmissions with multiple TRPs simultaneously. On the other hand, in order to achieve the diversity or multiplexing gain, the UE needs to perform reasonable uplink precoding, and the standard needs to provide more support in the uplink precoding.

In view of these, the present disclosure proposes enhancements on the uplink communication based on multipoint transmission, so as to support simultaneous signal transmission of a UE with multiple TRPs. Exemplary embodiments of the present disclosure will be described in detail below.

### First Embodiment

A first embodiment of the present disclosure will discuss uplink synchronization of transmission frames.

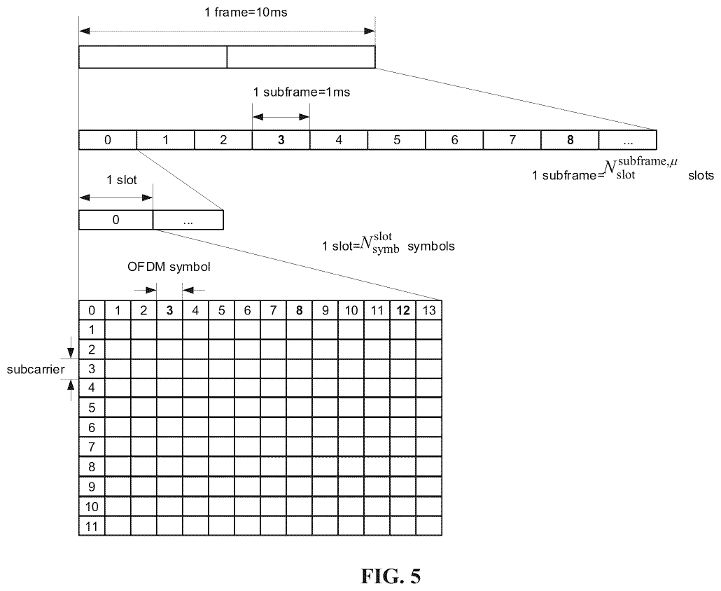

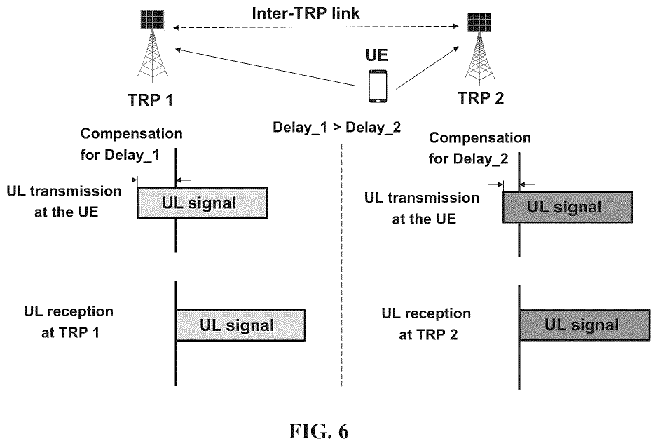

In the 5G NR, both downlink and uplink transmissions are organized into frames. FIG. 5 is a diagram showing a frame structure in the 5G communication system. As a fixed framework compatible with the LTE/LTE-A, a frame in the NR also has a length of 10 ms and comprises 10 equally sized subframes each being 1 ms. Unlike the LTE/LTE-A, the frame structure in the NR has a flexible framework depending on supported transmission numerologies μ, and for a different transmission numerology μ(e.g., 0-4), a supported subcarrier spacing Δf is also different, as shown in the following table:

TABLE 1
Supported transmission numerologies

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Each subframe has a configurable number Nₛₗₒₜ^{subframe, μ} of slots, e.g., 1, 2, 4, 8, 16. Each slot also has a configurable number N_{symb}^{slot} of OFDM symbols, each slot containing 14 consecutive OFDM symbols for normal Cyclic Prefix (CP) and 12 consecutive OFDM symbols for extended Cyclic Prefix. In frequency-domain dimension, each slot comprises several resource blocks, each resource block containing, for example, 12 consecutive subcarriers in the frequency domain. Thus, Resource Elements (REs) in a slot may be represented using a resource grid, as shown in FIG. 5. The resource blocks available for the uplink transmission may be divided into a data section and a control section. Resource elements in the control section may be allocated to the UE for transmission of control information. The data section may include all resource elements that are not included in the control section. Resource elements in the data section may also be allocated to the UE for transmitting data to the base station.

For the 5G NR, an important feature of the uplink transmission is that different UEs from the same cell utilize Orthogonal Frequency Division Multiple Access (OFDMA) so that uplink transmissions from different UEs within the cell do not interfere with each other. To ensure orthogonality of the uplink transmissions and avoid an intra-cell interference, the base station requires that different UE signals from the same subframe but different frequency-domain resources (different RBs) arrive at the base station substantially aligned in time. The base station can decode uplink data correctly as long as it receives the uplink signals transmitted by the UEs within a range of the cyclic prefix. Therefore, the uplink synchronization requires that arrival times of signals of the same subframe from different UEs at the base station fall within the cyclic prefix.

In order to ensure time synchronization on the receiving side (the base station side), a mechanism of uplink Timing Advance (TA) needs to be applied. From the UE side, the TA is essentially a negative offset between a time when a downlink subframe is received and a time when an uplink subframe is transmitted. The base station can control the arrival times of uplink signals from different UEs at the base station by appropriately controlling the offset of each UE. For a UE further away from the base station, due to the larger transmission delay, it transmits the uplink data more ahead than a UE closer to the base station.

In the multi-point transmission scenario, as shown in FIG. 6, the UE may simultaneously communicate with multiple TRPs (only two TRPs are shown in FIG. 6, hower, the present disclosure is not limited thereto), and in order to enable both of the two TRPs to correctly demodulate the received signals, the UE needs to configure the TA appropriately to ensure that the signals transmitted by the UE can arrive at times expected by the two TRPs, respectively. However, distances between the UE and the two TRPs may be different, which results in different propagation delays of the uplink signals transmitted by the UE to the two TRPs. Denote the propagation delays of the signals transmitted by the UE to TRP 1 and TRP 2 as Delay_1 and Delay_2, respectively, and without loss of generality, let Delay_1>Delay_2. In order to ensure that the TRP 1 can demodulate the uplink signal smoothly, the UE needs to configure a TA to compensate for Delay_1; similarly, in order to ensure demodulation by TRP 2, the UE needs to compensate for Delay_2. However, in the existing standard, the UE only uses one TA value during the uplink transmissions, and is unable to compensate for Delay_1 and Delay_2 at the same time. That is, the existing uplink synchronization can be adapted well to the multipoint transmissions that are based on time division, but cannot support the multipoint transmissions that are performed simultaneously.

As used in the present disclosure, “simultaneous” transmissions mean that the uplink transmissions to two or more TRPs occur together at least at certain times, that is, the uplink transmission frames to these TRPs overlap at least partially in the time domain.

An improved uplink synchronization process applicable to the multipoint transmission according to the first embodiment of the present disclosure is described below.

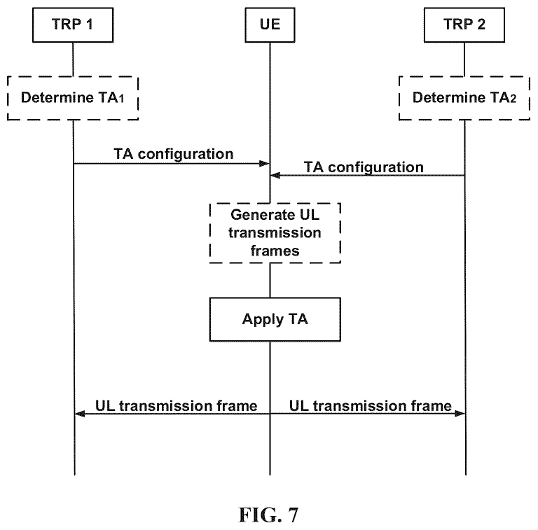

FIG. 7 is a signal flow diagram illustrating the uplink synchronization according to the first embodiment, in which a UE performs the multipoint transmission with TRP 1 and TRP 2. It should be noted that although only two TRPs are shown in FIG. 7, the number of TRPs is not limited thereto, and the UE may perform uplink transmissions simultaneously with more than two TRPs, and the process thereof may be analogized from the following description.

As shown in FIG. 7, each of the TRPs may determine a TA value that needs to be configured for the UE. In the present disclosure, how to determine the TA is not a critical feature, the TRP may measure or determine the TA value of the UE using various methods, and is briefly introduced here.

In one example, during a random access procedure, the TA value may be determined by the TRP by measuring a received random access preamble, and is sent to the UE through a Timing Advance Command field in a Random Access Response (RAR) message.

In another example, in an RRC_Connected state, the TRP needs to maintain TA information. Although the UE has achieved uplink synchronization with the TRP in the random access procedure, the timing of the uplink signal arriving at the TRP may change over time, for example, when the UE is in a high-speed motion, the transmission path changes, a crystal oscillator of the UE is shifted, or the like. Therefore, the UE needs to continuously update its uplink TA amount to maintain the uplink synchronization. The TRP may instead estimate the TA value based on measurements of various uplink transmission signals (e.g., SRS, PUSCH, PUCCH, or the like) of the UE. The estimated TA value may be sent to the UE through a Timing Advance Command field in a Timing Advance MAC CE.

The multiple TRPs may independently determine and configure TA values for the UE. For example, as shown in FIG. 7, TRP 1 may determine an associated timing advance value TA₁ for the UE based on signal measurements, and TRP 2 may determine a timing advance value TA₂ for the UE based on signal measurements. It is assumed here that TA₁ determined by TRP 1 differs from TA₂ determined by TRP 2.

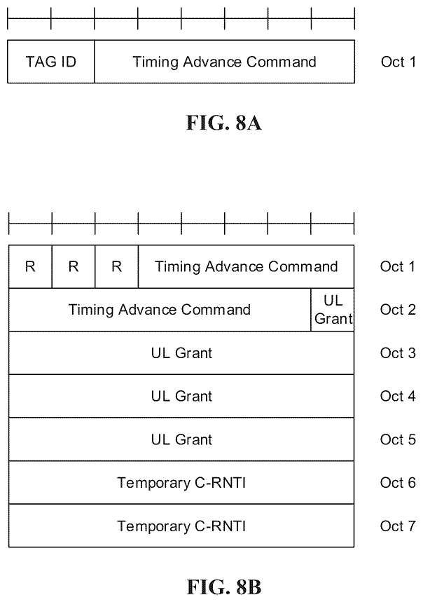

Next, each of the TRPs may configure the TA determined for the UE to the UE through control signaling. For example, the TRP may configure the TA to the UE through a Timing Advance Command MAC CE or a Random Access Response. FIG. 8A shows an example of the Timing Advance Command MAC CE, in which a TAG ID field represents an ID of a Timing Advance Group (TAG), and occupies 2 bits; a Timing Advance Command field represents a TA index value for controlling a timing adjustment amount, and occupies 6 bits to indicate index values 0 to 63. FIG. 8B shows an example of the random access response, where R is a reserved field; a Timing Advance Command field represents a TA index value for controlling a timing adjustment amount, and occupies 12 bits to indicate an index value of 0-3846; a UL grant field represents resources to be used on the uplink; a temporary C-RNTI field represents a temporary ID used by the UE in the random access phase. It should be noted that the TA configuration method is not limited to the above signaling, and the TRP may transmit the determined TA value to the UE using various possible downlink control signaling.

When the UE has data to transmit, a Scheduling Request (SR) and/or a Buffer Status Report (BSR) may be transmitted to the TRP to request time-frequency resources for transmitting the user data. In a resource scheduling pattern of dynamic grant, the TRP may dynamically schedule a PUSCH using DCI including resource allocation information. In a resource scheduling pattern of configured grant, the TRP can pre-configure available time-frequency resources for the UE through RRC layer signaling, so that the UE can directly utilize the pre-configured time-frequency resources to perform PUSCH transmission without requesting the base station to send uplink grant every time.

On the UE side, user data from the MAC layer is to be treated as “Transport Blocks (TB s)”, and needs to undergo a series of uplink physical layer processing in order to be mapped to a transport channel in the physical layer. The uplink physical layer processing generally includes: Cyclic Redundancy Check (CRC) addition to transport blocks, code block segmentation and code block CRC addition, channel coding, physical layer HARQ processing, rate matching, scrambling, modulation, layer mapping, transform precoding and precoding, mapping to allocated resources and antenna ports, and so on. By means of various signal processing functions of the physical layer, a bit stream as the user data is coded and modulated into OFDM symbols and transmitted by an antenna array to corresponding TRP using the allocated time-frequency resources. Accordingly, the TRP which receives the signal decodes the user data through an inverse process of the above signal processing.

In particular, the UE may transmit the same data to TRP 1 and TRP 2 in order to obtain a diversity gain; alternatively, the UE may transmit different data to TRP 1 and TRP 2 in order to obtain a multiplexing gain. The UE organizes the data to be transmitted to the TRP 1 and TRP 2 respectively into uplink transmission frames.

The UE needs to apply a TA to each of the generated uplink transmission frames to determine a final transmission timing. It is assumed that the UE needs to transmit respective uplink transmission frames to TRP 1 and TRP 2 at the same time, which means that the uplink transmission frame to TRP 1 and the uplink transmission frame to TRP 2 overlap at least partially in the time domain.

To implement different TAs associated with the TRPs, according to the first embodiment, two exemplary approaches to apply the TAs are provided.

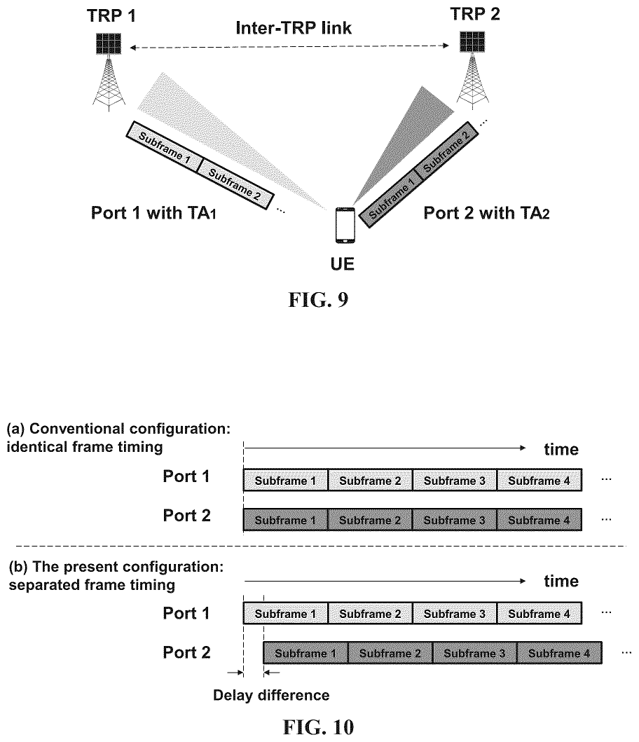

The first is an approach based on antenna port, and this configuration approach requires the UE to have multiple antenna ports. The UE may use different antenna ports to perform uplink transmissions with multiple TRPs, and the UE may configure one TA value for each port, so that the multiple antenna ports may implement the configuration of multiple TA values. FIG. 9 shows a schematic diagram of a UE applying TAs on antenna ports. As shown in FIG. 9, the UE transmits data to TRP 1 through Antenna Port 1 and transmits data to TRP 2 through Antenna Port 2. The UE may apply a TA value associated with TRP 1 (i.e., TA₁) on Antenna Port 1 to compensate for the propagation delay Delay_1 between the UE and TRP 1. Further, the UE may apply a TA value associated with TRP 2 (i.e., TA₂) on Antenna Port 2 to compensate for the propagation delay Delay_2 between the UE and TRP 2. Thereby, the uplink synchronization of the UE with both TRP 1 and TRP 2 is achieved.

Here, the UE may have many available antenna ports, and how to establish an association between the antenna port and the TA value may be in various ways, depending on implementations at the UE without any particular limitation. In one example, the UE may associate a certain TA value with one or more antenna ports in advance, for example, TA₁ with Antenna Port 1 (and possibly other ports), and TA₂ with Antenna Port 2 (and possibly other ports), and then choose to use the antenna port associated with TA₁, such as Antenna Port 1, in the uplink transmission with TRP 1, and choose to use the antenna port associated with TA₂, such as Antenna Port 2, in the uplink transmission with TRP 2. In another example, an antenna port may be first assigned to each TRP for use, for example, Antenna Port 1 is assigned to TRP 1, and Antenna Port 2 is assigned to TRP 2, and then, in the uplink transmissions, the UE applies TA₁ to the assigned Antenna Port 1, and TA₂ to the assigned Antenna Port 2.

FIG. 10 shows a comparison between conventional TA configuration and the TA configuration according to the first embodiment of the present disclosure. As shown in FIG. 10, in the conventional configuration, each of antenna ports of the UE adopts the same timing frame structure, and the configuration in which different TA values correspond to different ports cannot be implemented; however, with the configuration of the present disclosure, each antenna port may adopt a different timing frame structure, and specifically, there is an offset in time between Port 1 and Port 2, and the offset is equal to the difference between Delay_1 and Delay_2.

It should be noted that when the multiple-TA configuration is implemented using different antenna ports, a problem regarding Layer Mapping is also involved. The layer mapping is a process of mapping symbols to be transmitted, {d⁽⁰⁾(0), d⁽⁰⁾(1), d⁽⁰⁾(2), . . . }, to different spatial data streams (referred to as “spatial layers”), {x⁽⁰⁾(i), x⁽¹⁾(i), x⁽²⁾(i), . . . }. Referring to FIG. 11, conventional layer mapping scheme is shown as a table on the left side, which defines one-to-one mapping from data symbols to spatial layers, ensuring that each symbol corresponds to an individual layer. However, in the multi-point transmission scenario, when the UE desires to obtain a diversity gain to improve the link reliability, it is necessary to transmit the same data symbol to multiple different TRPs. At this time, if the multi-TA configuration is implemented by using different antenna ports, a case occurs that the same symbol may be transmitted by multiple antenna ports.

According to the first embodiment, non-one-to-one layer mapping is proposed, that is, mapping from one data symbol to multiple spatial layers is allowed. As shown in FIG. 11, one transmission symbol d⁽⁰⁾(0) is mapped to two layers x⁽⁰⁾(i) and x⁽¹⁾(i) at the same time, and then transmitted to corresponding TRP 1 and TRP 2 through different Antenna Ports 1 and 2, respectively, thereby implementing the diversity gain.

The second approach to apply TAs is to implement the multi-TA configuration using different Bandwidth Parts (BWPs). BWP is a concept newly introduced by the 5G NR. Because the 5G bandwidth is large, in order to reduce power consumption of the user terminal, a BWP is set as a subset of the whole bandwidth, and the size of each BWP and the subcarrier spacing (SCS) and Cyclic Prefix (CP) used by it can be flexibly configured. According to the first embodiment of the present disclosure, the UE may use different BWPs to perform uplink transmissions with the plurality of TRPs, respectively, and the UE may configure one TA value for each BWP, so that the plurality of BWPs may implement the configuration with multiple TA values. For example, assuming that TRP 1 can be assigned to use resources on BWP1, and TRP2 can be assigned to use resources on BWP 2. The UE may apply a TA value associated with TRP 1 (i.e., TA₁) on BWP1 to compensate for the propagation delay Delay_1 between the UE and TRP 1. Further, the UE may apply a TA value associated with TRP2 (i.e., TA₂) on BWP2 to compensate for the propagation delay Delay_2 between the UE and TRP 2. Thereby, uplink synchronization of the UE with both TRP 1 and TRP2 is achieved.

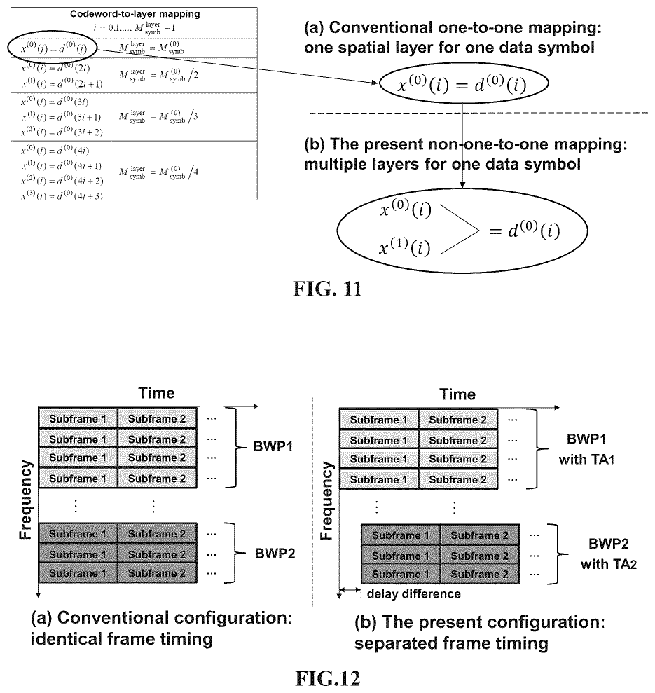

FIG. 12 shows a comparison between conventional TA configuration and the TA configuration according to the first embodiment of the present disclosure. As shown in FIG. 12, in the conventional configuration, the UE adopts the same timing frame structure on each BWP, and cannot implement the configuration with different TA values corresponding to different BWPs; while in the configuration of the present disclosure, various BWPs may employ different timing frame structures, and more specifically, BWP1 and BWP2 have an offset in time, an amount of which is equal to the difference between Delay_1 and Delay_2. Further, the UE matches its BWPs with corresponding TRPs, and the signal loaded to BWP1 by UE is demodulated by TRP 1, and the signal loaded to BWP2 by UE is demodulated by TRP2, so that different TA values configured on the two BWPs can compensate for the propagation delays from the UE to TRP 1 and TRP2, respectively. This configuration approach can be implemented without requiring the UE to have multiple antenna ports.

Returning to the signal flow diagram in FIG. 7, after the UE applies the TAs and determines the transmission timing, the UE may transmit respective uplink transmission frame to each of the TRPs. According to the first embodiment of the present disclosure, since different TAs are applied in the spatial domain (e.g., on antenna ports) or in the frequency domain (e.g., on BWPs), the transmissions can be implemented even if the uplink transmission frames to TRP 1 and TRP2 overlap in the time domain.

At each of the TRPs, the uplink transmission frame from the UE, due to the application of the appropriate TA, can arrive at the TRP substantially simultaneously with uplink transmission frames from other UEs within the same cell, so that the TRP can correctly demodulate the uplink data of each UE.

Through the uplink synchronization process according to the first embodiment, the UE can perform uplink data transmission with multiple TRPs really “simultaneously”, which improves the transmission efficiency or reliability.

Next, an electronic device and a communication method that can implement the first embodiment are described.

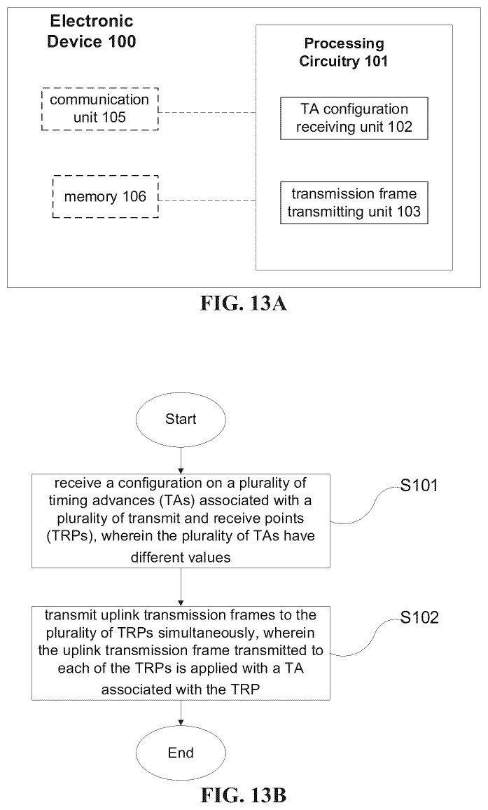

FIG. 13A is a block diagram illustrating an electronic device 100 according to the present disclosure. The electronic device 100 may be a UE or a component of a UE.

As shown in FIG. 13A, the electronic device 100 includes processing circuitry 101. The processing circuitry 101 includes at least a TA configuration receiving unit 102 and a transmission frame transmitting unit 103. The processing circuitry 101 may be configured to perform the communication method illustrated in FIG. 13B.

The TA configuration receiving unit 102 in the processing circuitry 101 is configured to receive a configuration on a plurality of TAs associated with a plurality of TRPs, that is, to perform step S101 in FIG. 13B. The plurality of TAs as received may have different values. The TA configuration receiving unit 102 may receive the TA configuration associated with each of the TRPs through control signaling such as a Timing Advance Command MAC CE or a Random Access Response.

The transmission frame transmitting unit 103 is configured to transmit uplink transmission frames to the plurality of TRPs simulatenously, that is, to perform step S102 in FIG. 13B. The transmission frame transmitting unit 103 is further configured to apply respective TA to the uplink transmission frame to each of the TRPs, so as to compensate for a signal propagation delay, for example, the TA associated with each of the TRPs may be applied on the antenna port or BWP for the TRP, so as to determine a transmission timing of each uplink transmission frame. Alternatively, in a case where the same data is transmitted to the plurality of TRPs, the same data symbol may be mapped onto a plurality of spatial layers so as to be transmitted to the plurality of TRPs through corresponding antenna ports, respectively.

The electronic device 100 may also include, for example, a communication unit 105 and a memory 106.

The communication unit 105 may be configured to communicate with the TRPs under the control of the processing circuitry 101. In one example, the communication unit 105 may be implemented as a transmitter or transceiver, including communication components such as antenna arrays and/or radio frequency links. The communication unit 105 is depicted with a dashed line because it may also be located outside the electronic device 100.

The electronic device 100 may also include the memory 106. The memory 106 may store various data and instructions, such as programs and data for operation of the electronic device 100, various data generated by the processing circuitry 101, and the like. The memory 106 is depicted with a dashed line because it may also be located within the processing circuitry 101 or outside the electronic device 100.

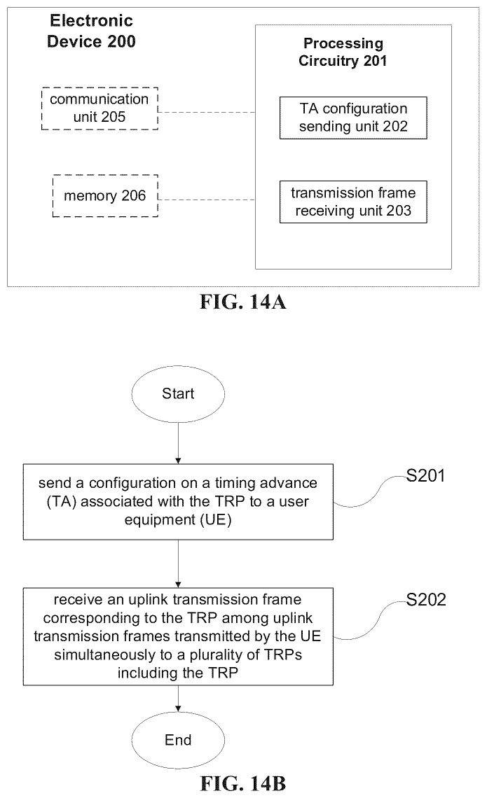

FIG. 14A is a block diagram illustrating an electronic device 200 according to the present disclosure. The electronic device 200 may be a base station (TRP) or a component of a base station.

As shown in FIG. 14A, the electronic device 200 includes processing circuitry 201. The processing circuitry 201 includes at least a TA configuration sending unit 202 and a transmission frame receiving unit 203. The processing circuitry 201 may be configured to perform the communication method shown in FIG. 14B.

The TA configuration sending unit 202 of the processing circuitry 201 is configured to send a configuration on a TA associated with the TRP to the UE, that is, to perform step S201 in FIG. 14B. The TA configuration sending unit 202 may send the TA configuration associated with the TRP through control signaling such as a Timing Advance Command MAC CE or a Random Access Response.

The transmission frame receiving unit 203 is configured to receive an uplink transmission frame corresponding to the TRP among uplink transmission frames transmitted simultaneously by the UE to a plurality of TRPs including the TRP, that is, to perform step S202 in FIG. 14B. In particular, the uplink transmission frames transmitted to the plurality of TRPs are applied with different TAs associated with each of the TRPs, respectively.

The electronic device 200 may further include, for example, a communication unit 205 and a memory 206.

The communication unit 205 may be configured to communicate with the UE under control of the processing circuitry 201. In one example, the communication unit 205 may be implemented as a transmitter or transceiver, including communication components such as antenna arrays and/or radio frequency links. The communication unit 205 is depicted with a dashed line because it may also be located outside the electronic device 200.

The electronic device 200 may also include the memory 206. The memory 206 may store various data and instructions, such as programs and data for operation of the electronic device 200, various data generated by the processing circuitry 201, various control signaling or traffic data received by the communication unit 205, data to be transmitted by the communication unit 205, and the like. The memory 206 is depicted with a dashed line because it may also be located within the processing circuitry 201 or outside the electronic device 200.

### Second Embodiment

A second embodiment of the present disclosure will discuss uplink precoding.

In the multi-point transmission scenario, the UE may send data to different TRPs by using multiple antenna ports, which may involve a problem of designing the uplink precoding. In terms of the uplink precoding, the current standard supports two patterns, namely, codebook-based and non-codebook-based.

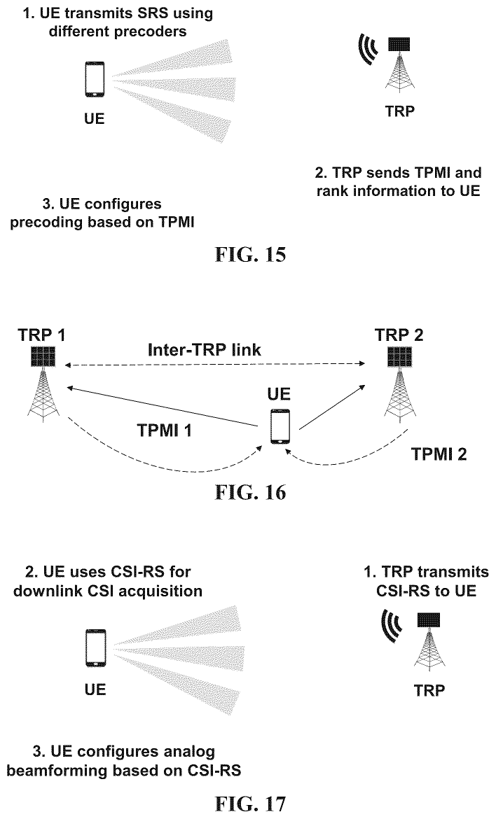

In the codebook-based precoding pattern, the uplink precoder selected by the UE is selected from a codebook given by the standard. A process for deciding the uplink precoder is as shown in FIG. 15, where the UE configures different precoders to transmit a Sounding Reference Signal (SRS), the TRP determines an optimal precoder (i.e., a precoding matrix) by detecting the SRS, and then issues a precoding matrix indication (TPMI) to the UE, wherein the TPMI indicates the precoder that should be used by the UE. And after receiving the TPMI and other information, the UE selects and configures a corresponding precoder from the codebook.

It should be noted that, under the existing standard framework, the uplink precoder is actually determined by the TRP, however, in the multi-point transmission scenario, as shown in FIG. 16, different TRPs may issue different TPMIs to the UE (TRP 1 issues TPMI 1, and TRP2 issues TPMI 2) to indicate different precoders, which causes a difficulty in selection at the UE, and the UE can only select one precoder randomly, for example, the precoder indicated by TPMI 1, but this precoder may not be adapted to a channel condition between the UE and TRP 2.

In the non-codebook-based precoding pattern, as shown in FIG. 17, the UE performs uplink precoding according to downlink channel condition information. First, the UE detects a Channel State Information Reference Signal (CSI-RS) configured by the TRP, estimates a downlink channel condition, and then directly configures an analog beamforming (also referred to as analog precoding) vector according to the downlink channel condition without performing digital precoding. Such uplink transmission scheme depends on reciprocity (degree of association) between uplink and downlink channels, and it is difficult to guarantee the performance of uplink transmission.

As can be seen from the above, the existing uplink precoding mechanism may not be suitable for the multi-point transmission scenario, because the UE may not be able to select the most suitable precoder or even not perform the digital precoding. Therefore, there is a need to improve the existing uplink precoding mechanism to improve the transmission performance.

According to the second embodiment of the present disclosure, the uplink precoder is decided by the UE, instead of the TRP, and the TRP merely issues various information to provide reference for the UE to make the decision, rather than give a command that the UE must execute.

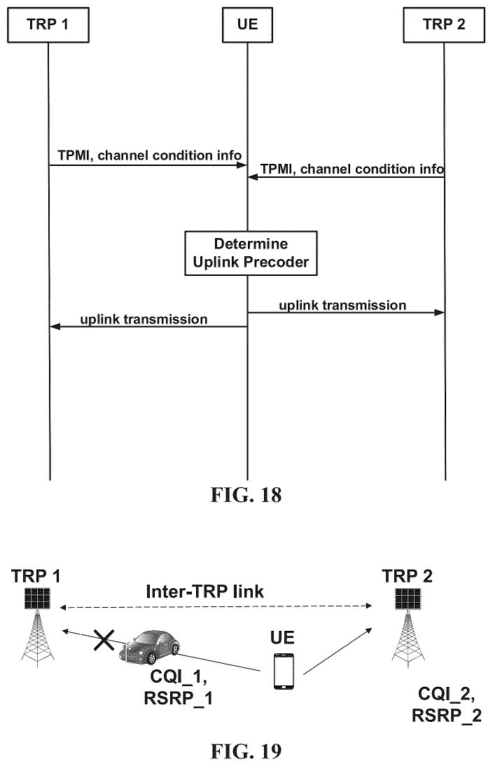

FIG. 18 shows an example of the uplink precoding according to the second embodiment. As shown in FIG. 18, each of the TRPs may send information that assists the UE in deciding an uplink precoder. Unlike the existing mechanism, the information sent by the TRP includes channel condition information such as Channel Quality Information (CQI) or Reference Signal Received Power (RSRP), in addition to the conventional TPMI. This is because the inventor has recognized that the channel quality should actually be a factor in considering the uplink precoding, for example, as shown in FIG. 19, when the channel quality between the UE and a certain TRP (TRP 1) is poor due to shielding or the like, the UE should tend to configure a precoder according to the TPMI issued by another TRP (TRP 2) having better channel quality, but the TPMI alone cannot reflect actual condition of each channel, while the CQI or RSRP measured by the TRP may be used as important reference information. Here, TPMI, CQI, or RSRP may be determined by the TRP by measuring SRS (not shown in the figure) transmitted by the UE.

When the TPMI and channel condition information are received from each of the TRPs, the UE can make a decision based on the information to select an optimal precoder from a codebook of precoders. The selection process can be described as

$${max}_{w} \cdot max \{ {β}_{1} {‖ {H}_{1} w ‖}_{F}^{2} , {β}_{2} {‖ {H}_{2} w ‖}_{F}^{2} \}$$

$$s . t . w ∈ ℱ$$

where w is a precoder; [symbol] is a feasible codebook set, containing all optional precoders; β₁ and β₂ are large-scale fading conditions (including path loss, shadow fading and the like) between the UE and the two TRPs, respectively, and are obtained by the UE from information such as CQI/RSRP issued by the TRP; and H₁ and H₂ are channel matrices between the UE and TRP 1 and TRP2, respectively.

Subsequently, the UE may precode data to be transmitted to the TRP 1 and TRP 2 using the selected precoder and transmit it to TRP 1 and TRP 2, respectively.

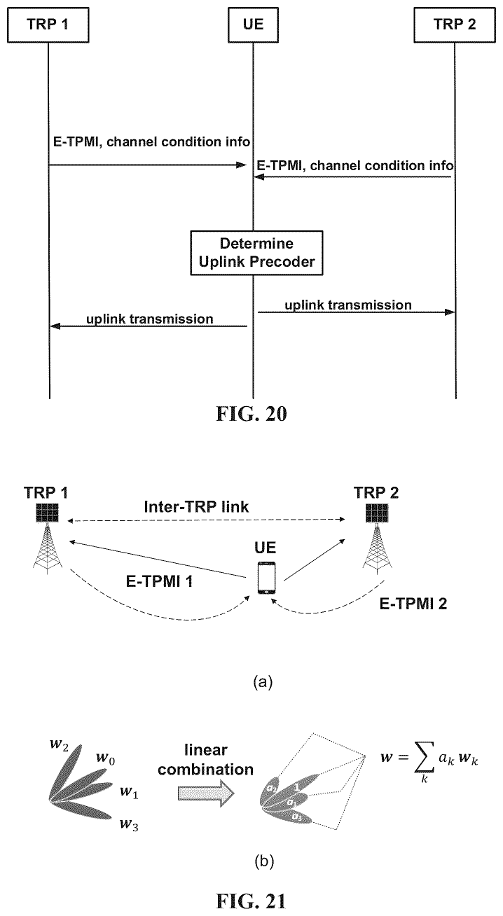

FIG. 20 shows another example of the uplink precoding according to the second embodiment. The difference from the example described with reference to FIG. 18 is that each of the TRPs transmits an enhanced TPMI (E-TPMI) to the UE. Unlike the conventional TPMI which indicates a specific precoder, the E-TPMI issued by the TRP is used to indicate a linear combination of multiple optional precoders. As shown in FIG. 21, TRP 1 may determine a linear combination of a set of optional precoders (e.g., w₀, w₁, w₂, w₃), that is, w=Σₖaₖwₖ,where aₖ represents a weight for the respective precoder. TRP 1 then issues E-TPMI 1 representing this linear combination to the UE. In addition, based on the SRS measurement sent by the UE, the TRP2 may determine another different linear combination of the set of optional precoders, and issue E-TPMI 2 representing this linear combination to the UE.

The E-TPMI according to the second embodiment may be an index of various linear combinations of a set of precoders. For example, assuming that the optional precoders include w0, w1, w2 and w3, whose weights may be 0 or 1, and 15 linear combinations (except the linear combination of all 0) are preset, and one of these linear combinations is indexed by the E-TPMI. Of course, the weight for each of the precoders may not be limited to 0 or 1, but may be a further value (e.g., 0.5), and there may be more linear combinations, which means that the number of bits required for E-TPMI is larger.

Upon receiving the E-TPMI and channel condition information from each of the TRPs, the UE can make a decision based on these information, that is, construct a linear combination of precoders from the codebook, and the selection process can be described as

$${max}_{w} \cdot max \{ {β}_{1} {‖ {H}_{1} w ‖}_{F}^{2} , {β}_{2} {‖ {H}_{2} w ‖}_{F}^{2} \}$$

$$s . t . w ∈ \{ {Fa}_{1} , {Fa}_{2} \}$$

where column vectors of the matrix F are all optional precoders; each element of the vector a₁ represents respective weight for each of the precoders in the linear combination determined by the TRP 1; each element of the vector a₂ represents respective weight for each of the precoders in the linear combination determined by TRP 2. Similarly, β₁ and β₂ are large-scale fading conditions (including path loss, shadow fading and the like) between the UE and the two TRPs, respectively, and are obtained by the UE from information such as CQI/RSRP issued by the TRP; and H₁ and H₂ are channel matrices between the UE and TRP 1 and TRP 2, respectively.

Assuming that a total of N optional precoders are contained in the codebook, that is, [symbol] ={w₁, w₂, . . . , w_{N}}, and the aforementioned matrix F can be represented as F=[w₁, . . . w_{N}], i.e., with all of the optional precoders as column vectors of the matrix F. At this time, a column vector a=[α₁, . . . α_{N}]^{T} of N×1 dimensions is taken, where αᵢ, 1≤i≤N, represents a weight for the precoder wᵢ in the linear combination, and according to matrix multiplication, Fa=Σᵢ₌₁^{N}αᵢwᵢ can be obtained, which represents a linear combination of varous precoders with elements in the vector as weights.

Thus, the UE can construct a linear combination of precoders as the precoder for uplink transmission, which is different from the conventional selection of a particular precoder. Subsequently, the UE may precode data to be transmitted to the TRP 1 and TRP 2 using the constructed precoder and transmit it to TRP 1 and TRP 2, respectively.

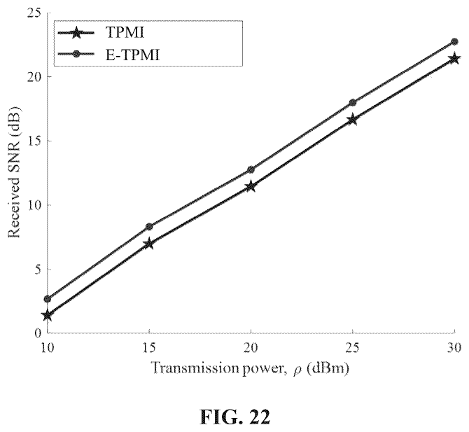

The inventor of the present disclosure simulated the uplink precoding as described with reference to FIG. 18 (i.e., using the conventional TPMI) and the uplink precoding as described with reference to FIG. 20 (i.e., using the enhanced TPMI), and set the number of TRP antennas to N_{TRP}=8×8, the number of UE antennas to N_{UE}=2×2, and the cell radius to 500m. FIG. 22 shows a result of the simulation, in which the abscissa represents a transmission power ρ and the ordinate represents a received signal-to-noise ratio (SNR).

As can be seen from the performance comparison in FIG. 22, the enhanced TPMI can effectively improve the signal-to-noise ratio on the receiving side compared to the conventional TPMI, thereby improving the link performance.

Next, an electronic device and a communication method that can

implement the second embodiment are described.

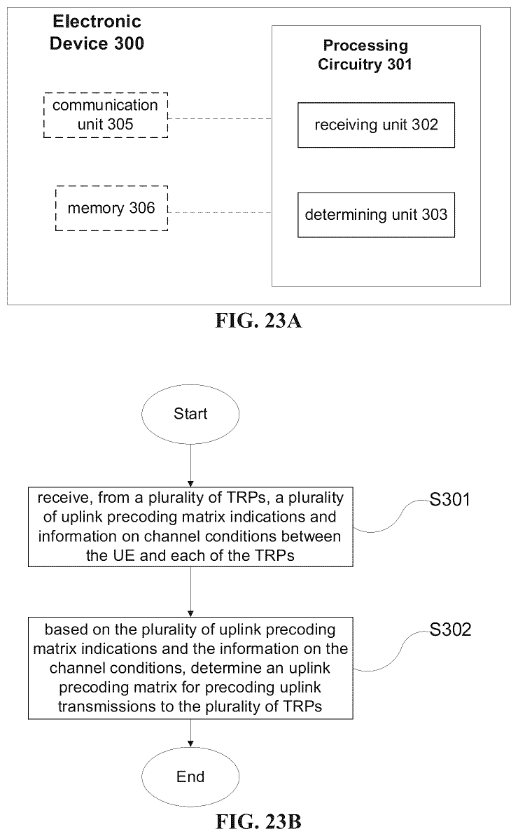

FIG. 23A is a block diagram illustrating an electronic device 300 according to the present disclosure. The electronic device 300 may be a UE or a component of a UE.

As shown in FIG. 23A, the electronic device 300 includes processing circuitry 301. The processing circuitry 301 comprises at least a receiving unit 302 and a determining unit 303. The processing circuitry 301 may be configured to perform the communication method shown in FIG. 23B.

The receiving unit 302 in the processing circuitry 301 is configured to receive, from a plurality of TRPs, a plurality of uplink precoding matrix indications and information on channel conditions between the UE and each of the TRPs, respectively, that is, to perform step S301 in FIG. 23B. In one example, the plurality of uplink precoding matrix indications received by the receiving unit 302 may be conventional TPMIs, while in another example, the plurality of uplink precoding matrix indications may be enhanced TPMIs, each indicating a linear combination of a set of precoders determined by the TRP. The information on channel conditions may include CQI and/or RSRP.

The determining unit 303 is configured to determine an uplink precoding matrix for precoding uplink transmissions with the plurality of TRPs based on the plurality of uplink precoding matrix indications and the information on channel conditions received by the receiving unit 302, that is, to perform step S302 in FIG. 23B. In one example, the determining unit 303 may select an optimal precoder from a plurality of precoders indicated by the plurality of uplink precoding matrix indications based on the channel condition information. In another example, the determining unit 303 may construct a linear combination of a set of optional precoders for uplink precoding, based on the plurality of uplink precoding matrix indications and the channel condition information.

The electronic device 300 may further comprise, for example, a communication unit 305 and a memory 306.

The communication unit 305 may be configured to communicate with the TRPs under control of the processing circuitry 301. In one example, the communication unit 305 may be implemented as a transmitter or transceiver, including communication components such as antenna arrays and/or radio frequency links. The communication unit 305 is depicted with a dashed line because it may also be located outside the electronic device 300.

The electronic device 300 may also include the memory 306. The memory 306 may store various data and instructions, such as programs and data for operation of the electronic device 300, various data generated by the processing circuitry 301, and the like. The memory 306 is depicted with a dashed line because it may also be located within the processing circuitry 301 or outside the electronic device 300.

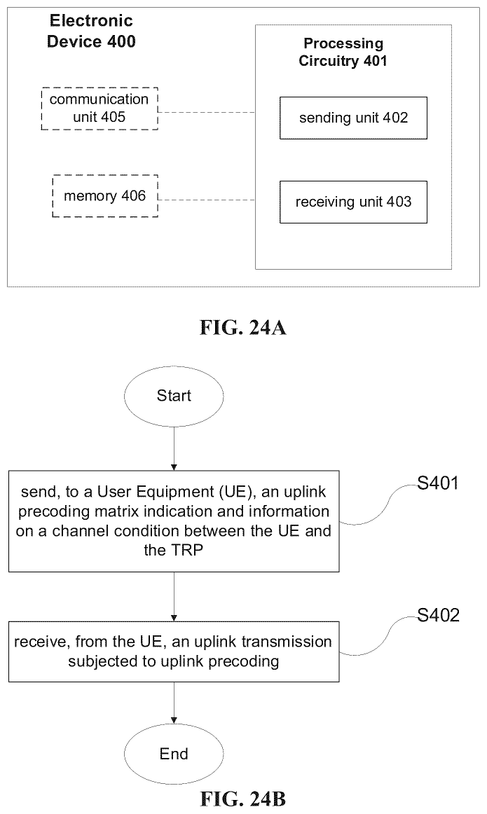

FIG. 24A is a block diagram illustrating an electronic device 400 according to the present disclosure. The electronic device 400 may be a base station (TRP) or a component of a base station.

As shown in FIG. 24A, the electronic device 400 includes processing circuitry 401. The processing circuitry 401 comprises at least a sending unit 402 and a receiving unit 403. The processing circuitry 401 may be configured to perform the communication method shown in FIG. 24B.

The sending unit 402 of the processing circuitry 401 is configured to send an uplink precoding matrix indication and information on channel condition between the UE and this TRP to the UE, that is, to perform step S401 in FIG. 24B. In one example, the uplink precoding matrix indication may be a conventional TPMI, while in another example, the uplink precoding matrix indication may be an enhanced TPMI, which indicates a linear combination of a set of precoders determined by the TRP. The information on channel condition may include CQI and/or RSRP.

The receiving unit 403 is configured to receive uplink transmission subjected to uplink precoding from the UE, that is, to perform step S402 in FIG. 24B. In particular, the uplink precoding utilizes an uplink precoder determined by the UE, for example, one of a set of optional precoders or a linear combination thereof, based on the uplink precoding matrix indications transmitted by a plurality of TRPs including this TRP and information on channel conditions between the UE and each of the TRPs.

The electronic device 400 may also include, for example, a communication unit 405 and a memory 406.

The communication unit 405 may be configured to communicate with the UE under control of the processing circuitry 401. In one example, the communication unit 405 may be implemented as a transmitter or transceiver, including communication components such as antenna arrays and/or radio frequency links. The communication unit 405 is depicted with a dashed line, since it may also be located outside the electronic device 400.

The electronic device 400 may also include the memory 406. The memory 406 may store various data and instructions, such as programs and data used for operation of the electronic device 400, various data generated by the processing circuitry 401, various control signaling or traffic data received by the communication unit 405, data to be transmitted by the communication unit 405, and the like. The memory 406 is depicted with a dashed line because it may also be located within the processing circuitry 401 or outside the electronic device 400.

Various aspects of the embodiments of the present disclosure have been described in detail above, but it should be noted that the structure, arrangement, type, number, etc. of the antenna array as shown, the ports, the reference signals, the communication devices, the communication methods and the like as described above are not intended to limit aspects of the present disclosure to these particular examples.

It should be noted that the units of the electronic devices 100, 200, 300 and 400 described in the above embodiments are only logical modules divided according to specific functions implemented by the units, and are not intended to be limited to the specific implementations. In an actual implementation, the above units may be implemented as independent physical entities, or may also be implemented by a single entity (for example, a processor (CPU, DSP, or the like.), an integrated circuit, etc.).

It should be noted that the units of the electronic devices 100, 200, 300 and 400 described in the above embodiments are only logical modules divided according to specific functions implemented by the units, and are not intended to be limited to the specific implementations. In an actual implementation, the above units may be implemented as independent physical entities, or may also be implemented by a single entity (for example, a processor (CPU or DSP, etc.), an integrated circuit, etc.).

The processing circuitry 101, 201, 301 or 401 may refer to various implementations of a digital circuitry, an analog circuitry, or a circuitry for hybrid signal (a combination of analog signal and digital signal) that perform functions in a computing system. The processing circuitry may include, for example, circuitry such as an Integrated Circuit (IC), an Application Specific Integrated Circuit (ASIC), portions or circuits of an individual processor core, an entire processor core, an individual processor, a programmable hardware device such as a Field Programmable Gate Array (FPGA), and/or a system including multiple processors.

Furthermore, the memory 106, 206, 306 or 406 may be a volatile and/or non-volatile memory. For example, the memory may include, but are not limited to, Random Access Memory (RAM), Dynamic Random Access Memory (DRAM), Static Random Access Memory (SRAM), Read Only Memory (ROM), flash memory.

### Exemplary Implementation of the Present Disclosure

According to the embodiment of the present disclosure, various implementations that embody the concepts of the present disclosure are conceivable, including but not limited to:

1). An electronic device on user side, comprising:
a processing circuitry configured to
   receive a configuration on a plurality of timing advances (TAs) associated with
a plurality of transmit and receive points (TRPs), wherein the plurality of TAs have different values; and
   transmit uplink transmission frames to the plurality of TRPs simultaneously, wherein the uplink transmission frame transmitted to each of the TRPs is applied with a TA associated with the TRP.

2). The electronic device of 1), wherein the uplink transmission frames transmitted to the plurality of TRPs at least partially overlap in time domain.

3). The electronic device of 1), wherein the processing circuitry is further configured to apply, to an antenna port used for uplink transmission to each of the TRPs, a TA associated with the TRP.

4). The electronic device of 1), wherein the processing circuitry is further configured to apply, to a bandwidth part (BWP) used for uplink transmission to each of the TRPs, a TA associated with the TRP.

5). The electronic device of 3), wherein the processing circuitry is further configured to map the same data symbol to multiple layers for transmission to the plurality of TRPs via respective antenna ports.

6). An electronic device for a transmit and receive point (TRP), comprising:
a processing circuitry configured to
   send a configuration on a timing advance (TA) associated with the TRP to a user equipment (UE); and
   receive an uplink transmission frame corresponding to the TRP among uplink transmission frames transmitted by the UE simultaneously to a plurality of TRPs including the TRP, wherein the uplink transmission frames transmitted to the plurality of TRPs are applied with different TAs associated with respective TRPs.

7). The electronic device of 6), wherein the uplink transmission frames transmitted to the plurality of TRPs at least partially overlap in time domain.

8). The electronic device of 6), wherein the UE applies, to an antenna port used for uplink transmission to each of the TRPs, a TA associated with the TRP.

9). The electronic device of 6), wherein the UE applies, to a bandwidth part (BWP) used for uplink transmission to each of the TRPs, a TA associated with the TRP.

10). An electronic device for a user equipment (UE), comprising:
a processing circuitry configured to
   receive, from a plurality of TRPs, a plurality of uplink precoding matrix indications and information on channel conditions between the UE and each of the TRPs; and
   based on the plurality of uplink precoding matrix indications and the information on the channel conditions, determine an uplink precoder for precoding uplink transmissions to the plurality of TRPs.

11). The electronic device of 10), wherein the plurality of uplink precoding matrix indications represent different linear combinations associated with a set of precoders.

12). The electronic device of 11), wherein the determined uplink precoder is a linear combination associated with the set of precoders calculated by the UE.

13). The electronic device of 11), wherein the information on the channel conditions comprises one or more of a Channel Quality Indicator (CQI) and a Reference Signal Received Power (RSRP).

14). An electronic device for a transmit and receive point (TRP), comprising:
a processing circuitry configured to
   send, to a User Equipment (UE), an uplink precoding matrix indication and information on a channel condition between the UE and the TRP; and
   receive, from the UE, an uplink transmission subjected to uplink precoding, wherein the uplink precoding utilizes an uplink precoder determined by the UE based on uplink precoding matrix indications transmitted by a plurality of TRPs including the TRP and information on channel conditions between the UE and each of the TRPs.

15). The electronic device of 14), wherein the uplink precoding matrix indications transmitted by the plurality of TRPs are indicative of different linear combinations associated with a set of precoders.

16). A communication method, comprising:
receiving a configuration on a plurality of timing advances (TAs) associated with a plurality of transmit and receive points (TRPs), wherein the plurality of TAs have different values; and
transmitting uplink transmission frames to the plurality of TRPs simultaneously, wherein the uplink transmission frame transmitted to each of the TRPs is applied with a TA associated with the TRP.

17). A communication method, comprising:
sending a configuration on a timing advance (TA) associated with the TRP to a user equipment (UE); and
receiving an uplink transmission frame corresponding to the TRP among uplink transmission frames transmitted by the UE simultaneously to a plurality of TRPs including the TRP, wherein the uplink transmission frames transmitted to the plurality of TRPs are applied with different TAs associated with respective TRPs.

18). A communication method, comprising:
receiving, from a plurality of TRPs, a plurality of uplink precoding matrix indications and information on channel conditions between the UE and each of the TRPs; and
based on the plurality of uplink precoding matrix indications and the information on the channel conditions, determining an uplink precoder for precoding uplink transmissions to the plurality of TRPs.

19). A communication method, comprising:
sending, to a User Equipment (UE), an uplink precoding matrix indication and information on a channel condition between the UE and the TRP; and
receiving, from the UE, an uplink transmission subjected to uplink precoding, wherein the uplink precoding utilizes an uplink precoder determined by the UE based on uplink precoding matrix indications transmitted by a plurality of TRPs including the TRP and information on channel conditions between the UE and each of the TRPs.

20). A computer program product containing executable instructions which, when executed, implement the communication method according to any of 16)-19).

21). A non-transitory computer-readable storage medium containing executable instructions which, when executed, implement the communication method according to any of 16)-19).

### Application Example of the Present Disclosure

The techniques described in the present disclosure can be applied to various products.

For example, the electronic device 200 or 400 accroding to the embodiment of the present disclosure may be implemented as various base stations or installed in various base stations, and the electronic device 100 or 300 accroding to the embodiment of the present disclosure may be implemented as various user equipment or installed in various user equipment.

The communication method accroding to the embodiment of the present disclosure can be implemented by various base stations or user equipment; the methods and operations according to the embodiment of the present disclosure may be embodied as computer-executable instructions, stored in a non-transitory computer-readable storage medium, and may be executed by various base stations or user equipment to implement one or more of the functions described above.

The techniques according to the embodiment of the present disclosure may be made as various computer program products to be used in various base stations or user equipment to implement one or more of the functions described above.

The control device as described in the present disclosure may be implemented as any type of base stations, preferably, such as a macro gNB or a ng-eNB defined in the 3GPP 5G NR communication standar. A gNB may be a gNB that covers a cell smaller than a macro cell, such as a pico gNB, micro gNB, and home (femto) gNB. Instead, the base station may be implemented as any other types of base stations such as a NodeB, eNodeB and a base transceiver station (BTS). The base station may include a main body configured to control wireless communication, and one or more remote radio heads (RRH), a wirelesss relay, a drone control tower, a control node in an automated plant or the like disposed in a different place from the main body. In D2D, M2M, and V2V communication scenarios, a logical entity having a control function for communication may also be referred to as a base station. In cognitive radio communication scenario, a logical entity that performs a spectrum coordination function may also be referred to as a base station. In an automated plant, a logical entity that provides the network control function may be referred to as a base station.

The user equipment may be implemented as a mobile terminal such as a smartphone, a tablet personal computer (PC), a notebook PC, a portable game terminal, a portable/dongle type mobile router, and a digital camera apparatus, or an in-vehicle terminal such as a car navigation device. The user equipment may also be implemented as a terminal (that is also referred to as a machine type communication (MTC) terminal) that performs machine-to-machine (M2M) communication, a drone, a sensor or effector in an automated plant or the like. Furthermore, the user equipment may be a wireless commnunication module (such as an integrated circuit module including a single die) mounted on each of the above terminals.

Examples of the base station and the user equipment to which the techniques of the present disclosure may be applied are briefly described below.

### 1. Application Examples of the Base Station

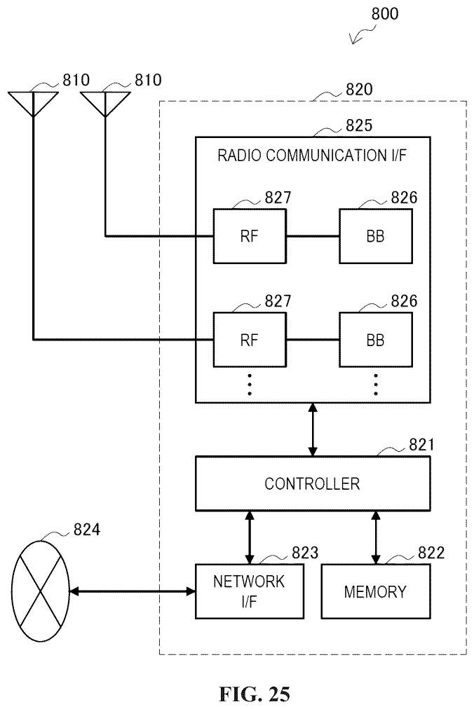

FIG. 25 is a block diagram illustrating a first example of a schematic configuration of the base station to which the technique of the present disclosure may be applied. In the uplink transmission, the base station may be implemented as or included in the electronic device 200 or 400. In FIG. 25, the base station is illustrated as an gNB 800. The gNB 800 includes a plurality of antennas 810 and a base station device 820. The base station device 820 and each antenna 810 may be connected with each other via a RF cable.

The antennas 810 may include one or more antenna arrays, and the antenna array includes multiple antenna elements (such as multiple antenna elements included in a Multiple Input and Multiple Output (MIMO) antennas), and is used for the base station 820 to transmit and receive radio signals. The gNB 800 may include multiple antennas 810, as illustrated in FIG. 25. For example, the multiple antennas 810 may be compatible with multiple frequency bands used by the gNB 800. FIG. 25 illustrates the example in which the gNB 800 includes multiple antennas 810.

The base station device 820 includes a controller 821, a memory 822, a network interface 823, and a radio communication interface 825.

The controller 821 may be, for example, a CPU or a DSP, and operates various functions of a higher layer of the base station device 820. For example, the controller 821 may include the processing circuitry 201 or 401 as described above, perform the communication method as descriebd in the above embodiments, or control the components of the electronic device 200 or 400. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in corporation with an gNB or a core network node in the vicinity. The memory 822 includes RAM and ROM, and stores a program that is executed by the controller 821, and various types of control data such as a terminal list, transmission power data, and scheduling data.

The network interface 823 is a communication interface for connecting the base station device 820 to a core network 824. The controller 821 may communicate with a core network node or another gNB via the network interface 823. In that case, the gNB 800, and the core network node or the other gNB may be connected to each other through a logical interface such as an S1 interface and an X2 interface. The network interface 823 may also be a wired communication interface or a radio communication interface for radio backhaul. If the network interface 823 is a radio communication interface, the network interface 823 may use a higher frequency band for radio communication than a frequency band used by the radio communication interface 825.

The radio communication interface 825 supports any cellular communication scheme such as Long Term Evolution (LTE), LTE-A or NR, and provides radio connection to a terminal positioned in a cell of the gNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers such as L1, medium access control (MAC), radio link control (RLC), and a packet data convergence protocol (PDCP). The BB processor 826 may have a part or all of the above-described logical functions instead of the controller 821. The BB processor 826 may be a memory that stores a communication control program, or a module that includes a processor configured to execute the program and a related circuit. Updating the program may allow the functions of the BB processor 826 to be changed. The module may be a card or a blade that is inserted into a slot of the base station device 820. Alternatively, the module may also be a chip that is mounted on the card or the blade. Meanwhile, the RF circuit 827 may include, for example, a mixer, a filter, and an amplifier, and transmits and receives radio signals via the antenna 810.

The radio communication interface 825 may include the multiple BB processors 826, as illustrated in FIG. 25. For example, the multiple BB processors 826 may be compatible with multiple frequency bands used by the gNB 800. The radio communication interface 825 may include the multiple RF circuits 827, as illustrated in FIG. 25. For example, the multiple RF circuits 827 may be compatible with multiple antenna elements. Although FIG. 25 illustrates the example in which the radio communication interface 825 includes the multiple BB processors 826 and the multiple RF circuits 827, the radio communication interface 825 may also include a single BB processor 826 or a single RF circuit 827.

In the gNB 800 illustrated in FIG. 25, one or more of the units included in the processing circuitry 201 described with reference to FIG. 14A or in the processing circuitry 401 described with reference to FIG. 24A may be implemented in the radio communication interface 825. Alternatively, at least a part of these components may be implemented in the controller 821. As an example, the gNB 800 includes a part (for example, the BB processor 826) or the entire of the radio communication interface 825 and/or a module including the controller 821, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 800, and the radio communication interface 825 (for example, the BB processor 826) and/or the controller 821 may execute the program. As described above, as a device including the one or more components, the gNB 800, the base station device 820 or the module may be provided. In addition, a readable medium in which the program is recorded may be provided.

### Second Application Example of the Base Station

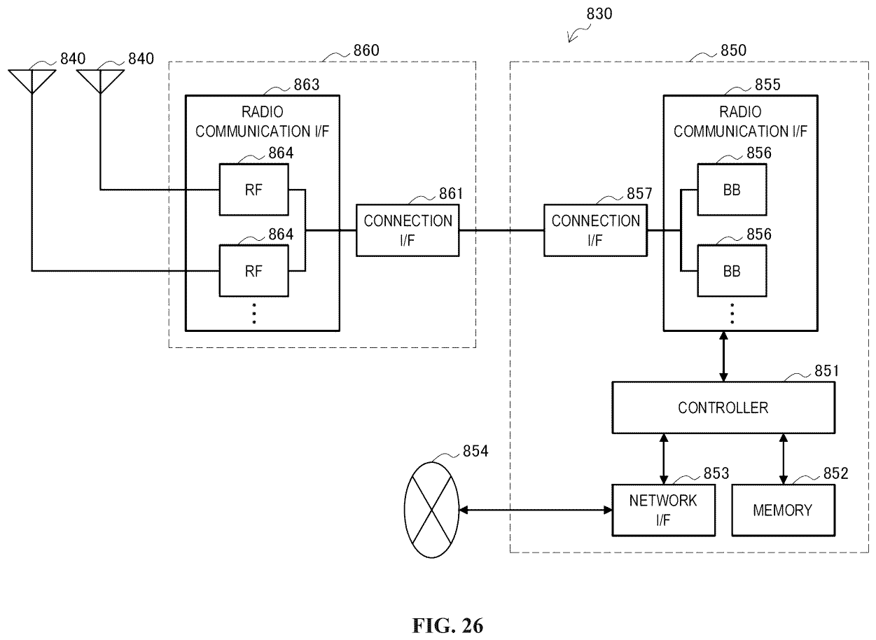

FIG. 26 is a block diagram illustrating a second example of a schematic configuration of the base station to which the techniques of the present application may be applied. In the uplink transmission, the base station may be implemented as the electronic device 200 or 400. In FIG. 26, the base station is illustrated as gNB 830. The gNB 830 includes one or more antennas 840, a base station device 850, and an RRH 860. Each antenna 840 and the RRH 860 may be connected to each other via an RF cable. The base station device 850 and the RRH 860 may be connected to each other via a high speed line such as an optical fiber cable.

The antennas 840 includes one or more antenna arrays. The antenna array includes multiple antenna elements such as multiple antenna elements included in an MIMO antenna and is used for the RRH 860 to transmit and receive radio signals. The gNB 830 may include multiple antennas 840, as illustrated in FIG. 26. For example, multiple antennas 840 may be compatible with multiple frequency bands used by the gNB 830. FIG. 26 illustrates an example in which the gNB 830 includes multiple antennas 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 25.

The radio communication interface 855 supports any cellular communication scheme such as LTE, LTE-A or NR, and provides radio communication to a terminal positioned in a sector corresponding to the RRH 860 via the RRH 860 and the antenna 840. The radio communication interface 855 may typically include, for example, a BB processor 856. The BB processor 856 is the same as the BB processor 826 described with reference to FIG. 25, except the BB processor 856 is connected to the RF circuit 864 of the RRH 860 via the connection interface 857. The radio communication interface 855 may include the multiple BB processors 856, as illustrated in FIG. 26. For example, multiple BB processors 856 may be compatible with multiple frequency bands used by the gNB 830. Although FIG. 26 illustrates the example in which the radio communication interface 855 includes multiple BB processors 856, the radio communication interface 855 may also include a single BB processor 856.

The connection interface 857 is an interface for connecting the base station device 850 (radio communication interface 855) to the RRH 860. The connection interface 857 may also be a communication module for communication in the above-described high speed line that connects the base station device 850 (radio communication interface 855) to the RRH 860.

The RRH 860 includes a connection interface 861 and a radio communication interface 863.

The connection interface 861 is an interface for connecting the RRH 860 (radio communication interface 863) to the base station device 850. The connection interface 861 may also be a communication module for communication in the above-described high speed line.

The radio communication interface 863 transmits and receives radio signals via the antenna 840. The radio communication interface 863 may typically include, for example, the RF circuit 864. The RF circuit 864 may include, for example, a mixer, a filter, and an amplifier, and transmits and receives radio signals via the antenna 840. The radio communication interface 863 may include multiple RF circuits 864, as illustrated in FIG. 26. For example, multiple RF circuits 864 may support multiple antenna elements. Although FIG. 26 illustrates the example in which the radio communication interface 863 includes the multiple RF circuits 864, the radio communication interface 863 may also include a single RF circuit 864.

In the gNB 830 illustrated in FIG. 26, one or more of the units included in the processing circuitry 201 described with reference to FIG. 14A or in the processing circuitry 401 described with reference to FIG. 24A may be implemented in the radio communication interface 855. Alternatively, at least a part of these components may be implemented in the controller 851. As an example, the gNB 830 include a part (for example, the BB processor 856) or the entire of the radio communication interface 855 and/or a module including the controller 851, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the gNB 830, and the radio communication interface 855 (for example, the BB processor 856) and/or the controller 851 may execute the program. As described above, as a device including the one or more components, the gNB 830, the base station device 850 or the module may be provided. A program causing the processor to function as the one or more components may also be provided. In addition, a readable medium in which the program is recorded may be provided.

### First Application Example of the User Device

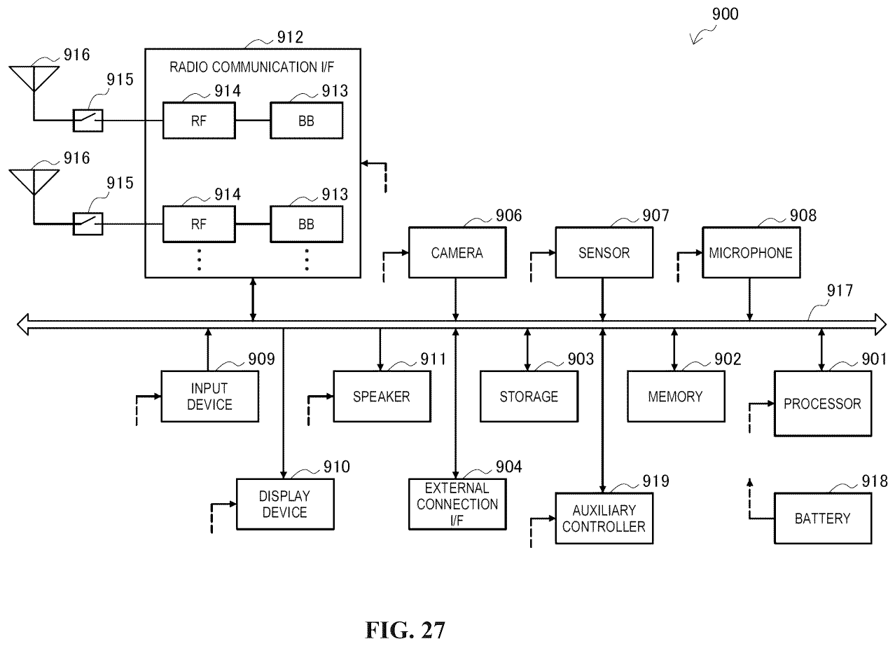

FIG. 27 is a block diagram illustrating an example of a schematic configuration of a smartphone 900 to which the techniques of the present application may be applied. In the uplink transmission, the smartphone 900 may be implemented as the electronic device 100 or 300. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and the other layers of the smartphone 900. The memory 902 includes RAM and ROM, and stores a program that is executed by the processor 901, and data. The storage 903 may include a storage medium such as a semiconductor memory and a hard disk. The external connection interface 904 is an interface for connecting an external device such as a memory card and a universal serial bus (USB) device to the smartphone 900.

The camera 906 includes an image sensor such as a charge coupled device (CCD) and a complementary metal oxide semiconductor (CMOS), and generates a captured image. The sensor 907 may include a group of sensors such as a measurement sensor, a gyro sensor, a geomagnetic sensor, and an acceleration sensor. The microphone 908 converts the sounds that are input to the smartphone 900 to audio signals. The input device 909 includes, for example, a touch sensor configured to detect touch onto a screen of the display device 910, a keypad, a keyboard, a button, or a switch, and receives an operation or an information input from a user. The display device 910 includes a screen such as a liquid crystal display (LCD) and an organic light-emitting diode (OLED) display, and displays an output image of the smartphone 900. The speaker 911 converts audio signals that are output from the smartphone 900 to sounds.

The radio communication interface 912 supports any cellular communication scheme such as LTE, LTE-A or NR, and performs radio communication. The radio communication interface 912 may typically include, for example, a BB processor 913 and an RF circuit 914. The BB processor 913 may perform, for example, encoding/decoding, modulating/demodulating, and multiplexing/demultiplexing, and performs various types of signal processing for radio communication. Meanwhile, the RF circuit 914 may include, for example, a mixer, a filter, and an amplifier, and transmits and receives radio signals via the antenna 916. The radio communication interface 912 may also be a one chip module that integrates the BB processor 913 and the RF circuit 914 thereon. The radio communication interface 912 may include multiple BB processors 913 and multiple RF circuits 914, as illustrated in FIG. 27. Although FIG. 27 illustrates the example in which the radio communication interface 912 includes multiple BB processors 913 and multiple RF circuits 914, the radio communication interface 912 may also include a single BB processor 913 or a single RF circuit 914.

Furthermore, in addition to a cellular communication scheme, the radio communication interface 912 may support another type of radio communication scheme such as a short-distance wireless communication scheme, a near field communication scheme, and a wireless local area network (LAN) scheme. In that case, the radio communication interface 912 may include the BB processor 913 and the RF circuit 914 for each radio communication scheme.

Each of the antenna switches 915 switches connection destinations of the antennas 916 among multiple circuits (such as circuits for different radio communication schemes) included in the radio communication interface 912.

The antennas 916 may include one or more antenna arrays. The antenna array includes multiple antenna elements such as multiple antenna elements included in an MIMO antenna, and is used for the radio communication interface 912 to transmit and receive radio signals. The smartphone 900 may include multiple antennas 916, as illustrated in FIG. 27. Although FIG. 27 illustrates the example in which the smartphone 900 includes multiple antennas 916, the smartphone 900 may also include a single antenna 916.

Furthermore, the smartphone 900 may include the antenna 916 for each radio communication scheme. In that case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 27 via feeder lines, which are partially shown as dashed lines in the figure. The auxiliary controller 919 operates a minimum necessary function of the smartphone 900, for example, in a sleep mode.

In the smartphone 900 illustrated in FIG. 27, one or more of the units included in the processing circuitry 101 described with reference to FIG. 13A or in the processing circuitry 301 described with reference to FIG. 23A may be implemented in the radio communication interface 912. Alternatively, at least a part of these components may also be implemented in the processor 901 or the auxiliary controller 919. As an example, the smartphone 900 include a part (for example, the BB processor 913) or the entire of the radio communication interface 912, and/or a module including the processor 901 and/or the auxiliary controller 919, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the smartphone 900, and the radio communication interface 912 (for example, the BB processor 913), the processor 901 and/or the auxiliary controller 919 may execute the program. As described above, as a device including the one or more components, the smartphone 900 or the module may be provided. A program causing the processor to function as the one or more components may also be provided. In addition, a readable medium in which the program is recorded may be provided.

### Second Application Example of the User Equipment

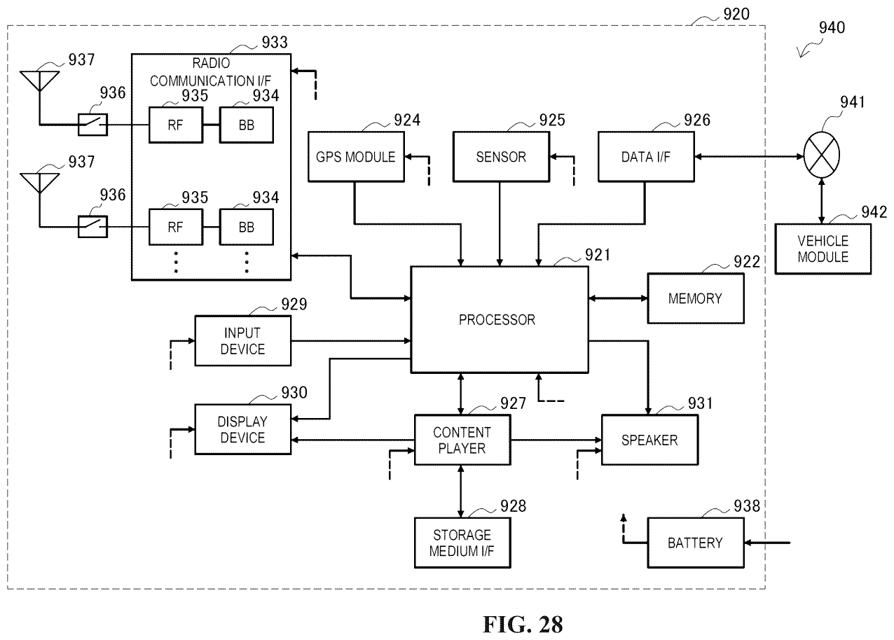

FIG. 28 is a block diagram illustrating an example of a schematic configuration of a car navigation device 920 to which an embodiment of the techniques of the present application may be applied. Wherein the car navigation device 920 can be implemented as the electronic device 100 desribed with reference to FIG. 13A or the electronic device 300 described with reference to FIG. 23A. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls a navigation function and other functions of the car navigation device 920. The memory 922 includes RAM and ROM, and stores a program that is executed by the processor 921, and data.

The GPS module 924 uses GPS signals received from a GPS satellite to measure a position, such as latitude, longitude, and altitude, of the car navigation device 920. The sensor 925 may include a group of sensors such as a gyro sensor, a geomagnetic sensor, and an air pressure sensor. The data interface 926 is connected to, for example, an in-vehicle network 941 via a terminal that is not shown, and acquires data generated by the vehicle, such as vehicle speed data.

The content player 927 reproduces content stored in a storage medium, such as a CD and a DVD, that is inserted into the storage medium interface 928. The input device 929 includes, for example, a touch sensor configured to detect touch onto a screen of the display device 930, a button, or a switch, and receives an operation or an information input from a user. The display device 930 includes a screen such as a LCD or an OLED display, and displays an image of the navigation function or content that is reproduced. The speaker 931 outputs sounds of the navigation function or the content that is reproduced.

The radio communication interface 933 supports any cellular communication scheme, such as LTE, LTE-A or NR, and performs radio communication. The radio communication interface 933 may typically include, for example, a BB processor 934 and an RF circuit 935. The BB processor 934 may perform, for example, encoding/decoding, modulating/demodulating, and multiplexing/demultiplexing, and performs various types of signal processing for radio communication. Meanwhile, the RF circuit 935 may include, for example, a mixer, a filter, and an amplifier, and transmits and receives radio signals via the antenna 937. The radio communication interface 933 may be a one chip module which integrates the BB processor 934 and the RF circuit 935 thereon. The radio communication interface 933 may include multiple BB processors 934 and multiple RF circuits 935, as illustrated in FIG. 28. Although FIG. 28 illustrates the example in which the radio communication interface 933 includes multiple BB processors 934 and multiple RF circuits 935, the radio communication interface 933 may also include a single BB processor 934 or a single RF circuit 935.

Furthermore, in addition to a cellular communication scheme, the radio communication interface 933 may support another type of radio communication scheme such as a short-distance wireless communication scheme, a near field communication scheme, and a wireless LAN scheme. In that case, the radio communication interface 933 may include the BB processor 934 and the RF circuit 935 for each radio communication scheme.

Each of the antenna switches 936 switches connection destinations of the antennas 937 among multiple circuits (such as circuits for different radio communication schemes) included in the radio communication interface 933.

The antennas 937 may include one or more antenna arrays. The antenna array includes multiple antenna elements, such as multiple antenna elements included in an MIMO antenna, and is used for the radio communication interface 933 to transmit and receive radio signals. The car navigation device 920 may include the multiple antennas 937, as illustrated in FIG. 28. Although FIG. 28 illustrates the example in which the car navigation device 920 includes multiple antennas 937, the car navigation device 920 may also include a single antenna 937.

Furthermore, the car navigation device 920 may include the antenna 937 for each radio communication scheme. In that case, the antenna switches 936 may be omitted from the configuration of the car navigation device 920.

The battery 938 supplies power to blocks of the car navigation device 920 illustrated in FIG. 28 via feeder lines that are partially shown as dashed lines in the figure. The battery 938 accumulates power supplied from the vehicle.

In the car navigation device 920 illustrated in FIG. 28, one or more of the units included in the processing circuitry 101 described with reference to FIG. 13A or in the processing circuitry 301 described with reference to FIG. 23A may be implemented in the radio communication interface 933. Alternatively, at least a part of these components may also be implemented in the processor 921. As an example, the car navigation device 920 includes a part (for example, the BB processor 934) or the entire of the radio communication interface 933 and/or a module including the processor 921, and the one or more components may be implemented in the module. In this case, the module may store a program (in other words, a program causing the processor to execute operations of the one or more components) causing the processor to function as the one or more components, and execute the program. As another example, a program causing the processor to function as the one or more components may be installed in the car navigation device 920, and the radio communication interface 933 (for example, the BB processor 934) and/or the processor 921 may execute the program. As described above, as a device including the one or more components, the car navigation device 920 or the module may be provided. A program causing the processor to function as the one or more components may also be provided. In addition, a readable medium in which the program is recorded may be provided.

The techniques of the present application may also be implemented as an in-vehicle system (or a vehicle) 940 including one or more blocks of the car navigation device 920, the in-vehicle network 941, and a vehicle module 942. The vehicle module 942 generates vehicle data such as vehicle speed, engine speed, and trouble information, and outputs the generated data to the in-vehicle network 941.

Although the illustrative embodiments of the present disclosure have been described with reference to the accompanying drawings, the present disclosure is certainly not limited to the above examples. Those skilled in the art may achieve various adaptions and modifications within the scope of the appended claims, and it will be appreciated that these adaptions and modifications certainly fall into the scope of the techniques of the present disclosure.

For example, in the above embodiments, the multiple functions included in one module may be implemented by separate means. Alternatively, in the above embodiemtns, the multiple functions included in multiple modules may be implemented by separate means, respectively. In additions, one of the above functions may be implemented by multiple modules. Needless to say, such configurations are included in the the scope of the techniques of the present disclosure.

In this specification, the steps described in the flowcharts include not only the processes performed sequentially in chronological order, but also the processes performed in parallel or separately but not necessarily performed in chronological order. Furthermore, even in the steps performed in chronological order, needless to say, the order may be changed appropriately.

Although the present disclosure and its advantages have been described in detail, it will be appreciated that various changes, replacements and transformations may be made without departing from the spirit and scope of the present disclosure as defined by the appended claims. In addition, the terms “include”, “comprise” or any other variants of the embodiments of the present disclosure are intended to be non-exclusive inclusion, such that the process, method, article or device including a series of elements includes not only these elements, but also those that are not listed specifically, or those that are inherent to the process, method, article or device. In case of further limitations, the element defiend by the sentence “include one” does not exclude the presence of additional same elements in the process, method, article or device including this element.

1. An electronic device on user side, comprising:
at least one processor; and
at least one memory including computer program code, wherein the at least one memory and the computer program code are configured, with the at least one processor, to cause the electronic device to
receive a configuration on a plurality of timing advances (TAs) associated with a plurality of transmit and receive points (TRPs), wherein the plurality of TAs have different values; and
transmit uplink transmission frames to the plurality of TRPs simultaneously, wherein the uplink transmission frame transmitted to each of the TRPs is applied with a TA associated with the TRP.

2. The electronic device of claim 1, wherein the uplink transmission frames transmitted to the plurality of TRPs at least partially overlap in time domain.

3. The electronic device of claim 1, wherein the processing circuitry is further configured to apply, to an antenna port used for uplink transmission to each of the TRPs, a TA associated with the TRP.

4. The electronic device of claim 1, wherein the processing circuitry is further configured to apply, to a bandwidth part (BWP) used for uplink transmission to each of the TRPs, a TA associated with the TRP.

5. The electronic device of claim 3, wherein the processing circuitry is further configured to map the same data symbol to multiple layers for transmission to the plurality of TRPs via respective antenna ports.

6. An electronic device for a transmit and receive point (TRP), comprising:
at least one processor; and
at least one memory including computer program code, wherein the at least one memory and the computer program code are configured, with the at least one processor, to cause the electronic device to
send a configuration on a timing advance (TA) associated with the TRP to a user equipment (UE); and
receive an uplink transmission frame corresponding to the TRP among uplink transmission frames transmitted by the UE simultaneously to a plurality of TRPs including the TRP, wherein the uplink transmission frames transmitted to the plurality of TRPs are applied with different TAs associated with respective TRPs.

7. The electronic device of claim 6, wherein the uplink transmission frames transmitted to the plurality of TRPs at least partially overlap in time domain.

8. The electronic device of claim 6, wherein the UE applies, to an antenna port used for uplink transmission to each of the TRPs, a TA associated with the TRP.

9. The electronic device of claim 6, wherein the UE applies, to a bandwidth part (BWP) used for uplink transmission to each of the TRPs, a TA associated with the TRP.

10. An electronic device for a user equipment (UE), comprising:
at least one processor; and
at least one memory including computer program code, wherein the at least one memory and the computer program code are configured, with the at least one processor, to cause the electronic device to
receive, from a plurality of TRPs, a plurality of uplink precoding matrix indications and information on channel conditions between the UE and each of the TRPs; and
based on the plurality of uplink precoding matrix indications and the information on the channel conditions, determine an uplink precoder for precoding uplink transmissions to the plurality of TRPs.

11. The electronic device of claim 10, wherein the plurality of uplink precoding matrix indications represent different linear combinations associated with a set of precoders.

12. The electronic device of claim 11, wherein the determined uplink precoder is a linear combination associated with the set of precoders calculated by the UE.

13. The electronic device of claim 11, wherein the information on the channel conditions comprises one or more of a Channel Quality Indicator (CQI) and a Reference Signal Received Power (RSRP).

14. An electronic device for a transmit and receive point (TRP), comprising:
at least one processor; and
at least one memory including computer program code, wherein the at least one memory and the computer program code are configured, with the at least one processor, to cause the electronic device to
send, to a User Equipment (UE), an uplink precoding matrix indication and information on a channel condition between the UE and the TRP; and
receive, from the UE, an uplink transmission subjected to uplink precoding, wherein the uplink precoding utilizes an uplink precoder determined by the UE based on uplink precoding matrix indications transmitted by a plurality of TRPs including the TRP and information on channel conditions between the UE and each of the TRPs.

15. The electronic device of claim 14, wherein the uplink precoding matrix indications transmitted by the plurality of TRPs are indicative of different linear combinations associated with a set of precoders.

16.-20. (canceled)
